(19) United States
(12) Patent Application Publication
(10) Pub. No.: US 2026/0340300 A1
(43) Pub. Date: Oct. 29, 2026

(54) SYSTEM

(71) Applicant: SoftBank Group Corp., Tokyo (JP)

(72) Inventor: Kosuke TAKEDA, Tokyo (JP)

(73) Assignee: SoftBank Group Corp., Tokyo (JP)

(21) Appl. No.: 19/534,799

(22) Filed: Feb. 10, 2026

(30) Foreign Application Priority Data
Feb. 21, 2025 (JP) 2025-027030

(51) Int. Cl. G06F 40/35; G06F 40/40; G06V 10/82; G06V 40/16; G10L 13/027; G10L 25/30; G10L 25/63

(52) U.S. Cl. CPC G06F 40/35; G06F 40/40; G06V 10/82; G06V 40/174; G10L 25/30; G10L 25/63; G10L 13/027

(57) ABSTRACT

The system according to the embodiment comprises an analysis unit, a generation unit, and a presentation unit. The analysis unit analyzes information input by a user. The generation unit generates small talk based on information extracted by the analysis unit. The presentation unit presents the small talk generated by the generation unit to the user.

### CROSS-REFERENCE TO RELATED APPLICATION

The present application claims priority to and incorporates by reference the entire contents of Japanese Patent Application No. 2025-027030 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that people who are not good at conversation find it difficult to smoothly engage in daily conversations.

### SUMMARY OF THE INVENTION

The system according to the embodiment comprises an analysis unit, a generation unit, and a presentation unit. The analysis unit analyzes information input by a user. The generation unit generates small talk based on information extracted by the analysis unit. The presentation unit presents the small talk generated by the generation unit to the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

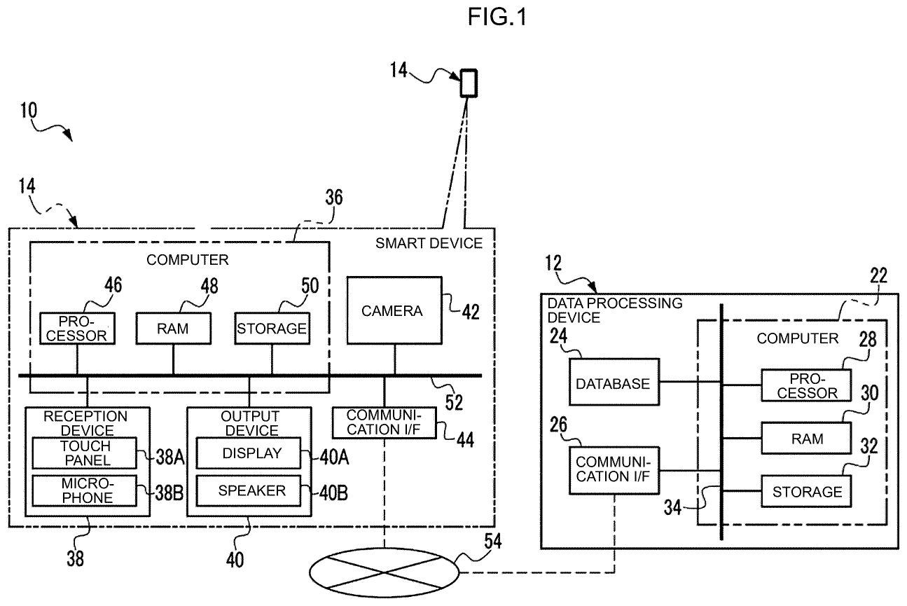

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

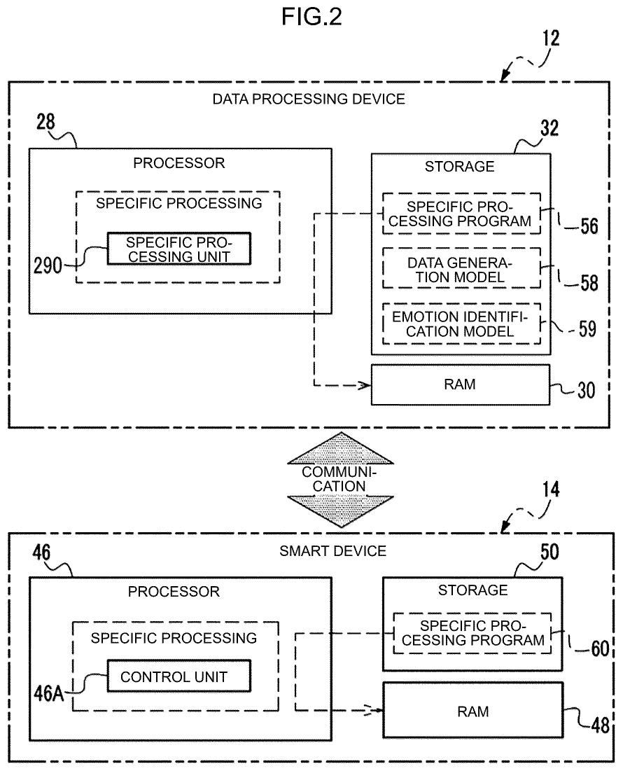

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The small talk generation system according to the embodiment of the present invention is a system targeting users who lack confidence in conversation, and creates small talk by connecting casual daily experiences. This small talk generation system allows users to input daily events or experiences, and a generation AI analyzes the input, extracts related topics or episodes, and generates small talk in a natural flow. The generated small talk is presented so that the user can use it in conversation. For example, when a user inputs “I went jogging in the park over the weekend,” the generation AI analyzes keywords such as “jogging” and “park,” extracts related topics or episodes, and, based on this information, generates small talk such as “The weather has been nice lately, so I went jogging in the park over the weekend. There were many people in the park, and everyone seemed to be having a good time. Have you been anywhere recently?” This small talk generation system supports users in developing natural conversations based on their casual daily experiences. As a result, even people who are not good at conversation can easily enjoy conversations and gain confidence in communication. Thus, the small talk generation system can support users in developing natural conversations based on their casual daily experiences. Specifically, the small talk generation system can accept daily events or experiences input by the user as text data (e.g., UTF-8 encoded natural language sentences, up to 512 tokens), audio data (e.g., 16 kHz, 16 bit PCM audio waveform, up to 30 seconds), or image data (e.g., 224×224 pixel RGB images). The analysis unit of the system applies natural language processing algorithms such as morphological analysis, named entity extraction, and dependency structure analysis to the input text data; for audio data, it uses a deep neural network-based speech recognition model (e.g., CTC-based acoustic model plus language model) to convert it to text; and for image data, it uses a convolutional neural network (CNN)-based image recognition model to extract features. The analysis unit integrates these preprocessing results and extracts main topics (e.g., “jogging,” “park,” “weather”) and episode candidates from the user's input. The extracted feature vectors (e.g., BERT embedding vectors, 768 dimensions) and keyword lists are input to the generation unit. The generation unit uses a large-scale language model (e.g., Transformer architecture, with more than 1 billion pre-trained parameters) to reconstruct the extracted topics and episodes into natural conversational sentences. For example, given input example 1 “I went jogging in the park over the weekend,” input example 2 “I went to a café0 with a friend yesterday,” and input example 3 “I've been into reading lately,” the generation unit generates small talk sentences such as “The weather has been nice lately, so I went jogging in the park over the weekend,” “Yesterday, I spent a relaxing time at a café with a friend,” and “I've been really into reading lately.” The output of the generation unit is structured data such as natural language text (UTF-8, up to 256 tokens), conversation labels (e.g., “casual,” “formal”), and related topic scores (real values from 0.0 to 1.0). The presentation unit can not only display the output of the generation unit on the user interface but also play it as audio data using a speech synthesis engine (e.g., Tacotron2 plus WaveNet). Furthermore, the generated small talk can be sent to the user's device (smartphone, tablet, PC, etc.) as push notifications or widgets, allowing the user to refer to it at any desired timing. This series of processes, unlike conventional human conversation support, is realized by combining operations in high-dimensional feature space and rule-based processing by multiple AI modules, resulting in technical effects such as faster processing speed, improved diversity and naturalness of conversation generation, and enhanced personalization accuracy for each user. Specific application fields include conversation support applications, communication training tools, mental healthcare support, customer support automation, and conversation practice support in the education field.

The small talk generation system according to the embodiment comprises an analysis unit, a generation unit, and a presentation unit. The analysis unit analyzes information input by the user. The information input by the user may include, for example, text, audio, images, and the like, but is not limited to such examples. The analysis unit, for example, analyzes text information input by the user using natural language processing technology. The analysis unit can also convert audio input into text using speech recognition technology and analyze the resulting text information. Furthermore, the analysis unit can analyze image input using image recognition technology and perform analysis based on information extracted from the image. The generation unit uses a generation AI to generate small talk based on information extracted by the analysis unit. The generation AI, for example, uses a text generation AI (such as an LLM) to generate small talk in a natural flow. The generation unit can also use the generation AI to combine related topics or episodes based on information extracted by the analysis unit to generate small talk. The generation AI may receive prompts such as “Summarize the main points of this text,” extract the main points of the input information, and generate small talk. The presentation unit presents the small talk generated by the generation unit to the user. The presentation unit, for example, displays the generated small talk in text format. The presentation unit can also present small talk to the user using audio output. Furthermore, the presentation unit can send the generated small talk to the user's device, allowing the user to check the small talk at any desired timing. Thus, the small talk generation system according to the embodiment can support users who lack confidence in conversation by analyzing information input by the user, generating small talk, and presenting it. Specifically, the small talk generation system is composed of three main modules: the analysis unit, the generation unit, and the presentation unit. The analysis unit can accept information input by the user in various data formats (text: UTF-8 encoded natural language sentences, up to 512 tokens; audio: 16 kHz, 16 bit PCM audio waveform, up to 30 seconds; image: 224×224 pixel RGB images). The analysis unit applies natural language processing algorithms such as morphological analysis, named entity extraction, and dependency structure analysis to text input; for audio input, it uses a deep neural network-based speech recognition model (e.g., CTC-based acoustic model plus language model) to convert it to text; and for image input, it uses a CNN-based image recognition model to extract features. The analysis unit integrates these preprocessing results and extracts main topics (e.g., “jogging,” “park,” “weather”) and episode candidates from the user's input. The extracted feature vectors (e.g., BERT embedding vectors, 768 dimensions) and keyword lists are input to the generation unit. The generation unit uses a large-scale language model (e.g., Transformer architecture, with more than 1 billion pre-trained parameters) to reconstruct the extracted topics and episodes into natural conversational sentences. For example, given input example 1 “I went jogging in the park over the weekend,” input example 2 “I went to a café with a friend yesterday,” and input example 3 “I've been into reading lately,” the generation unit generates small talk sentences such as “The weather has been nice lately, so I went jogging in the park over the weekend,” “Yesterday, I spent a relaxing time at a café with a friend,” and “I've been really into reading lately.” The output of the generation unit is structured data such as natural language text (UTF-8, up to 256 tokens), conversation labels (e.g., “casual,” “formal”), and related topic scores (real values from 0.0 to 1.0). The presentation unit can not only display the output of the generation unit on the user interface but also play it as audio data using a speech synthesis engine (e.g., Tacotron2 plus WaveNet). Furthermore, the generated small talk can be sent to the user's device (smartphone, tablet, PC, etc.) as push notifications or widgets, allowing the user to refer to it at any desired timing. This series of processes, unlike conventional human conversation support, is realized by combining operations in high-dimensional feature space and rule-based processing by multiple AI modules, resulting in technical effects such as faster processing speed, improved diversity and naturalness of conversation generation, and enhanced personalization accuracy for each user. Specific application fields include conversation support applications, communication training tools, mental healthcare support, customer support automation, and conversation practice support in the education field.

The analysis unit can analyze daily events or experiences input by the user and extract related topics or episodes. For example, the analysis unit analyzes daily events or experiences input by the user using natural language processing technology. For example, the analysis unit analyzes information such as “I went jogging in the park over the weekend” input by the user and extracts related topics or episodes such as “jogging” and “park.” The analysis unit can also analyze the context of information input by the user and extract related topics or episodes. For example, the analysis unit analyzes information such as “The weather has been nice lately, so I went jogging in the park over the weekend” input by the user and extracts related topics or episodes such as “weather” and “weekend.” Thus, by analyzing daily events or experiences input by the user and extracting related topics or episodes, the analysis unit can contribute to the generation of small talk. Specifically, the analysis unit accepts text data input by the user (e.g., UTF-8 encoded natural language sentences, up to 512 tokens), uses a morphological analyzer to segment the text into words, and applies named entity extraction algorithms (e.g., CRF-based, BERT-based) to extract names of people, places, events, etc. The analysis unit uses a dependency parser to clarify the relationships between subjects, predicates, and objects in the sentence and generates feature vectors for contextual understanding (e.g., BERT embedding vectors, 768 dimensions). When audio input (e.g., 16 kHz, 16 bit PCM waveform, up to 30 seconds) is received, the analysis unit extracts acoustic features (MFCC, spectrogram), converts the audio to text using a deep neural network-based speech recognition model (e.g., CTC-based), and applies similar natural language processing. When image input (e.g., 224×224 pixel RGB images) is received, the analysis unit extracts image features (e.g., global pooling vectors from ResNet50) using a CNN and generates text using an image captioning model (e.g., Image Captioning Transformer), which is then integrated with text analysis. The analysis unit integrates feature vectors and keyword lists obtained from these diverse inputs and uses clustering algorithms (e.g., K-means, hierarchical clustering) and similarity calculations (cosine similarity) to extract main topics and episode candidates. For example, in input example 1 “I went jogging in the park over the weekend,” topics such as “jogging,” “park,” and “weekend” are extracted; in input example 2 “The weather has been nice lately, so I went jogging in the park over the weekend,” topics such as “weather,” “weekend,” and “park” are extracted. The analysis unit assigns a relevance score (0.0 to 1.0) to each extracted topic and structures the data for input to the generation unit. By combining these processes with operations in high-dimensional feature space and rule-based processing, the analysis unit can integratively handle context dependency and diverse input modalities, unlike conventional simple keyword extraction by humans. As a technical effect, the analysis unit is robust to diversity and ambiguity in input content, greatly improves the accuracy of topic extraction for small talk generation, and contributes to personalization and naturalness of conversation for each user. Application fields include conversation support apps, educational conversation practice tools, customer support automation, and mental healthcare support.

The generation unit can generate small talk in a natural flow based on information extracted by the analysis unit. For example, the generation unit uses a generation AI to generate small talk based on information extracted by the analysis unit. The generation AI, for example, uses a text generation AI (such as an LLM) to generate small talk in a natural flow. The generation AI may receive prompts such as “Summarize the main points of this text,” extract the main points of the input information, and generate small talk. The generation unit can also use the generation AI to combine related topics or episodes based on information extracted by the analysis unit to generate small talk. For example, the generation unit generates small talk such as “The weather has been nice lately, so I went jogging in the park over the weekend. There were many people in the park, and everyone seemed to be having a good time. Have you been anywhere recently?” based on topics such as “jogging” and “park” extracted by the analysis unit. Thus, by generating small talk in a natural flow based on information extracted by the analysis unit, the generation unit enables the user to develop natural conversations. Specifically, the generation unit accepts structured data such as feature vectors (e.g., BERT embedding vectors, 768 dimensions), keyword lists, and relevance scores (0.0 to 1.0) received from the analysis unit as input. The generation unit uses a large-scale language model (e.g., Transformer architecture, with more than 1 billion pre-trained parameters), applies prompt engineering techniques such as “Summarize the main points of this text” or “Generate a natural conversational sentence including this topic,” and inputs the data to the model. Within the model, the generation unit uses a self-attention mechanism to dynamically understand relationships and context among input topics and generates natural conversational sentences. For example, given topic vectors such as “jogging,” “park,” and “weather” as input example 1, the generation unit generates small talk sentences such as “The weather has been nice lately, so I went jogging in the park over the weekend. There were many people in the park, and everyone seemed to be having a good time. Have you been anywhere recently?” The generation unit generates structured data as output, including natural language text (UTF-8, up to 256 tokens), conversation labels (e.g., “casual,” “formal”), and related topic scores (0.0 to 1.0). The generation unit applies grammar checking and redundancy removal algorithms (e.g., grammar error detection models, duplicate sentence removal rules) to the generated results to ensure the quality of the output sentences. The generation unit generates multiple candidate outputs (e.g., top N results by beam search) and selects the optimal small talk sentence based on relevance scores and diversity metrics (e.g., Distinct-n). Unlike conventional template-based or simple rule-based generation, the generation unit achieves dynamic context understanding and generation in high-dimensional feature space, greatly improving the naturalness, diversity, and personalization accuracy of conversation. As a technical effect, the generation unit can quickly and accurately generate natural conversational sentences optimized for each user, and is applicable to various fields such as conversation support apps, educational conversation practice tools, customer support automation, and mental healthcare support.

The presentation unit can present the generated small talk to the user. For example, the presentation unit displays the generated small talk in text format. The presentation unit may display the generated small talk on the screen of the user's device so that the user can use it in conversation. The presentation unit can also present the generated small talk to the user using audio output. For example, the presentation unit outputs the generated small talk as audio using speech synthesis technology so that the user can listen and understand it. Furthermore, the presentation unit can send the generated small talk to the user's device, allowing the user to check the small talk at any desired timing. For example, the presentation unit sends the generated small talk as a notification to the user's smartphone, allowing the user to check the small talk when needed. Thus, by presenting the generated small talk to the user, the presentation unit enables the user to use it in conversation. Specifically, the presentation unit accepts as input structured data received from the generation unit, such as natural language text (UTF-8, up to 256 tokens), conversation labels (e.g., “casual,” “formal”), and related topic scores (0.0 to 1.0). The presentation unit not only displays small talk in text format on user interfaces (e.g., screens of smartphones, tablets, PCs), but can also play it as audio data (16 kHz, 16 bit PCM waveform) using a speech synthesis engine (e.g., Tacotron2 plus WaveNet). The presentation unit obtains user device information (e.g., device type, screen size, OS version) and automatically selects the optimal display layout and notification method (e.g., push notification, widget display). The presentation unit can also analyze the user's reaction history log to preferentially select presentation methods (e.g., audio output, text display) that have previously received positive reactions from the user. By sending the generated small talk to the user's device and allowing the user to refer to it at any desired timing, the presentation unit enhances the convenience of conversation support. Unlike conventional simple text display or audio playback, the presentation unit dynamically selects the optimal presentation method according to the user's device environment and usage history, greatly improving user experience and the immediacy and flexibility of conversation support. As a technical effect, the presentation unit realizes optimized small talk presentation for each user and is applicable to various fields such as conversation support apps, educational conversation practice tools, customer support automation, and mental healthcare support.

The analysis unit can estimate the user's emotion and enhance the accuracy of analysis based on the estimated emotion of the user. For example, the analysis unit uses facial recognition technology to estimate the user's emotion. For example, the analysis unit captures the user's facial expression with a camera and estimates the user's emotion using a facial recognition algorithm. The analysis unit can also estimate the user's emotion using voice analysis technology. For example, the analysis unit analyzes the tone and speed of the user's voice to estimate the user's emotion. Furthermore, the analysis unit can estimate the user's emotion using text analysis technology. For example, the analysis unit analyzes the content and context of text input by the user to estimate the user's emotion. The analysis unit adjusts the accuracy of analysis based on the estimated emotion of the user. For example, if the user is relaxed, the analysis unit allows the generation AI to perform detailed analysis and extract more related topics. If the user is nervous, the analysis unit allows the generation AI to perform concise analysis and extract fewer topics. Furthermore, if the user is excited, the analysis unit allows the generation AI to prioritize topics related to emotion. Thus, by adjusting the accuracy of analysis based on the user's emotion, the analysis unit can obtain more appropriate analysis results. Emotion estimation is realized using, for example, an emotion engine or emotion estimation function of the generation AI. The generation AI may be a text generation AI (such as an LLM) or a multimodal generation AI, but is not limited to such examples. Specifically, the analysis unit integratively processes multiple input modalities for user emotion estimation. For facial recognition, the analysis unit inputs image data obtained from a camera (e.g., 640×480 pixel RGB images, 5 frames per second) to a CNN-based facial classification model (e.g., ResNet50 plus Softmax output layer) to estimate emotion labels such as “joy,” “sadness,” “surprise,” “anger,” and “relaxation.” For voice analysis, the analysis unit inputs 16 kHz, 16 bit PCM audio waveform data (up to 30 seconds), extracts acoustic features (MFCC, pitch, energy), and outputs emotion scores (0.0 to 1.0) such as “calmness,” “nervousness,” and “excitement” using an RNN or Transformer-based voice emotion recognition model. For text analysis, the analysis unit inputs natural language sentences (UTF-8, up to 512 tokens) entered by the user to a pre-trained language model such as BERT or RoBERTa, generates contextual embedding vectors (768 dimensions), and outputs emotion labels and probability distributions such as “positive,” “negative,” and “neutral” using an emotion classification head. For example, given input example 1 “I had a great time today” as text, input example 2 “audio with a trembling voice,” and input example 3 “image of a smiling face,” the analysis unit estimates emotions such as “joy,” “nervousness,” and “relaxation,” respectively. The analysis unit integrates emotion estimation results from multiple modalities using ensemble methods (e.g., weighted average, meta-classifier) to determine the final emotion label and score. The analysis unit dynamically adjusts parameters of subsequent feature extraction and topic extraction algorithms (e.g., number of clusters, thresholds, number of extracted topics) according to the estimated emotion. For example, in a relaxed state, the number of clusters is increased to extract diverse topics; in a nervous state, the threshold is raised to focus only on main topics. The analysis unit passes the estimated emotion as structured data (e.g., emotion label plus score plus confidence) to the generation unit, allowing the generation unit to adjust expression and level of detail during conversation generation. These processes, unlike conventional simple keyword extraction or subjective human judgment, are realized by computer-specific technical methods such as multimodal data integration in high-dimensional feature space, rule-based processing, and dynamic parameter control, resulting in technical effects such as improved emotion estimation accuracy, personalized conversation generation, and optimized user experience. Application fields include conversation support applications, mental healthcare support, emotion-adaptive conversation practice in education, and customer support automation.

The analysis unit can analyze the user's past input history and select an appropriate analysis method. For example, the analysis unit uses text logs to analyze the user's past input history. For example, the analysis unit saves text information previously input by the user as logs and analyzes those logs. The analysis unit can also use audio logs to analyze the user's past input history. For example, the analysis unit saves audio information previously input by the user as logs, converts the logs to text using speech recognition technology, and analyzes them. Furthermore, the analysis unit can use image logs to analyze the user's past input history. For example, the analysis unit saves image information previously input by the user as logs and analyzes the logs using image recognition technology. The analysis unit analyzes the user's past input history and selects the optimal analysis method. For example, the analysis unit allows the generation AI to propose new related topics based on topics previously input by the user. The analysis unit also extracts frequently used keywords from the user's past input history and reflects them in the analysis. Furthermore, the analysis unit analyzes the user's past input history and adjusts the analysis method based on specific patterns. Thus, by analyzing the user's past input history, the analysis unit can select the optimal analysis method and improve the accuracy of analysis. Specifically, the analysis unit manages a database of input history accumulated for each user in chronological order (e.g., text logs as UTF-8 natural language sentences, up to 1,000 entries; audio logs as 16 kHz, 16 bit PCM waveforms; image logs as 224×224 pixel RGB images). The analysis unit applies morphological analysis, named entity extraction, and topic modeling (e.g., LDA, BERTopic) to text history to calculate frequent keywords and topic distributions. Audio history is converted to text using a speech recognition model (e.g., CTC-based) and similar natural language processing is applied. Image history is processed using a CNN-based image recognition model (e.g., ResNet50) to extract features, and an image captioning model is used to convert images to text for integrated analysis. The analysis unit generates time-series feature vectors for each user (e.g., time-series arrays of BERT embedding vectors, each with 768 dimensions) and detects behavioral patterns and changes in interests using clustering or autoregressive models (e.g., ARIMA, LSTM). For example, input example 1 “I went jogging in the park over the weekend,” “I went to a café with a friend yesterday” as history; input example 2 “audio input at the same time every week” as a pattern; input example 3 “seasonal changes appearing in image history”—the analysis unit extracts the user's interests and behavioral tendencies in each case. The analysis unit optimizes analysis algorithm parameters (e.g., number of topics to extract, clustering thresholds, feature selection) for each user based on these analysis results and personalizes input data for the generation unit. Furthermore, the analysis unit calculates novelty scores and similarity scores from past history, enabling the generation unit to propose new topics and generate diverse conversations. These processes, unlike conventional simple history reference or reliance on human memory, are realized by computer-specific technical methods such as time-series analysis in high-dimensional feature space, self-learning algorithms, and multimodal integration, resulting in technical effects such as improved analysis accuracy for each user, increased diversity and novelty in conversation generation, and advanced personalization. Application fields include conversation support applications, personalized educational support, customer support automation, and mental healthcare support.

The analysis unit can perform filtering during analysis based on the user's current interests or trends. For example, the analysis unit uses social media data to identify the user's current interests. For example, the analysis unit analyzes topics frequently mentioned by the user on social media to identify current interests. The analysis unit can also use news articles to identify current trends. For example, the analysis unit collects the latest news articles and analyzes current trends. Furthermore, the analysis unit can reflect the latest information related to the user's interests in the analysis. For example, the analysis unit prioritizes analysis of topics that the user has recently shown interest in. Thus, by performing filtering based on the user's current interests or trends, the analysis unit can extract highly relevant topics. Specifically, the analysis unit accepts as input structured data obtained from the user's social media account, such as post data (e.g., latest 100 post texts, UTF-8, up to 256 tokens), like history, and follow relationships. The analysis unit uses natural language processing algorithms (e.g., BERT-based topic classifier, TF-IDF scoring) to calculate frequent keywords and topic distributions and identify the user's current interests. Furthermore, the analysis unit collects the latest news articles (e.g., 100 articles per day, title plus body text) from external news APIs or RSS feeds and extracts current social trends using topic modeling (e.g., LDA, BERTopic) or clustering. For example, input example 1 “the user frequently posts about sports,” input example 2 “climate change is a hot topic in the latest news,” input example 3 “the user has recently read many articles about travel”—the analysis unit extracts interest topics such as “sports,” “climate change,” and “travel” in each case. The analysis unit prioritizes extraction of information related to these topics and structures the data for input to the generation unit. The analysis unit calculates interest scores (0.0 to 1.0) and trend scores for the user and uses filtering algorithms (e.g., extracting only the top N scores, threshold setting) to extract only highly relevant topics. By combining these processes with multimodal data integration and rule-based processing in high-dimensional feature space, the analysis unit greatly improves real-time performance, diversity, and personalization accuracy, unlike conventional simple keyword extraction or subjective human judgment. As a technical effect, the analysis unit enables extraction of highly relevant topics in line with the user's current interests and social trends, improving the suitability, naturalness, and user satisfaction of conversation generation. Application fields include conversation support applications, personalized news recommendation, current event conversation practice in education, and customer support automation.

The analysis unit can estimate the user's emotion and determine the priority of topics to be analyzed based on the estimated emotion of the user. For example, the analysis unit uses facial recognition technology to estimate the user's emotion. For example, the analysis unit captures the user's facial expression with a camera and estimates the user's emotion using a facial recognition algorithm. The analysis unit can also estimate the user's emotion using voice analysis technology. For example, the analysis unit analyzes the tone and speed of the user's voice to estimate the user's emotion. Furthermore, the analysis unit can estimate the user's emotion using text analysis technology. For example, the analysis unit analyzes the content and context of text input by the user to estimate the user's emotion. The analysis unit determines the priority of topics to be analyzed based on the estimated emotion of the user. For example, if the user is relaxed, the analysis unit allows the generation AI to prioritize analysis of topics based on the user's interests. If the user is nervous, the analysis unit allows the generation AI to prioritize analysis of simple and easy-to-understand topics. Furthermore, if the user is excited, the analysis unit allows the generation AI to prioritize analysis of topics related to emotion. Thus, by determining the priority of topics to be analyzed based on the user's emotion, the analysis unit can prioritize analysis of topics important to the user. Emotion estimation is realized using, for example, an emotion engine or emotion estimation function of the generation AI. The generation AI may be a text generation AI (such as an LLM) or a multimodal generation AI, but is not limited to such examples. Specifically, the analysis unit integratively processes multiple input modalities (facial images, audio waveforms, text sentences) for user emotion estimation. For facial recognition, the analysis unit inputs camera images (e.g., 640×480 pixel RGB images, 5 frames per second) to a CNN-based facial classification model (e.g., ResNet50 plus Softmax) to estimate emotion labels such as “relaxation,” “nervousness,” and “excitement.” For voice analysis, the analysis unit extracts features such as MFCC and pitch from 16 kHz, 16bit PCM audio waveforms and outputs emotion scores (0.0 to 1.0) using an RNN or Transformer-based voice emotion recognition model. For text analysis, the analysis unit inputs natural language sentences (UTF-8, up to 512 tokens) to a pre-trained model such as BERT or RoBERTa and outputs emotion labels and probability distributions using an emotion classification head. For example, given input example 1 “I had a great time today” as text, input example 2 “audio with a trembling voice,” and input example 3 “image of a smiling face,” the analysis unit estimates emotions such as “relaxation,” “nervousness,” and “excitement,” respectively. The analysis unit integrates these emotion estimation results using ensemble methods to determine the final emotion label and score. The analysis unit dynamically applies topic extraction algorithm prioritization rules (e.g., prioritize user interest topics when relaxed, prioritize simple topics when nervous, prioritize emotion-related topics when excited) according to the estimated emotion. The analysis unit calculates relevance scores and emotion compatibility scores for each topic and passes a prioritized list to the generation unit. These processes, unlike conventional subjective human judgment or simple keyword extraction, are realized by computer-specific technical methods such as multimodal data integration in high-dimensional feature space, rule-based prioritization, and dynamic parameter control, resulting in technical effects such as optimized topic analysis for each user, personalized conversation generation, and improved user experience. Application fields include conversation support applications, emotion-adaptive educational support, mental healthcare support, and customer support automation.

The analysis unit can prioritize and analyze highly relevant topics by considering the user's geographic location information during analysis. For example, the analysis unit uses GPS data to obtain the user's geographic location information. For example, the analysis unit obtains the user's current location information from GPS data and analyzes related topics based on that location information. The analysis unit can also obtain the user's geographic location information using an IP address. For example, the analysis unit analyzes the user's IP address and analyzes related topics based on that location information. Furthermore, the analysis unit can reflect regional trends in the analysis based on the user's geographic location information. For example, the analysis unit prioritizes analysis of topics related to the user's current location. Thus, by considering the user's geographic location information, the analysis unit can prioritize analysis of region-related topics. Specifically, the analysis unit accepts as input GPS data obtained from the user's device (e.g., latitude and longitude information, accuracy within 5 meters, with timestamp) or location information estimated from IP address (e.g., city name, country name). The analysis unit cross-references location information with a geographic information database (e.g., OpenStreetMap, regional topic dictionary) and extracts topic candidates related to the current location (e.g., tourist spots, events, weather, regional news). Furthermore, the analysis unit collects region-specific latest trend information (e.g., local events, local news) from external news APIs or SNS and extracts related topics using natural language processing algorithms (e.g., BERT-based topic classifier). For example, input example 1 “the user is near Tokyo Station,” input example 2 “the user is traveling abroad,” input example 3 “the user is in a local city”—the analysis unit prioritizes extraction of regional topics such as “events near Tokyo Station,” “overseas travel information,” and “local specialties” in each case. The analysis unit calculates regional relevance scores (0.0 to 1.0) for each topic and structures the top-scoring topics as input data for the generation unit. By combining these processes with geographic information integration and rule-based prioritization in high-dimensional feature space, the analysis unit greatly improves regional adaptability, real-time performance, and personalization accuracy, unlike conventional simple keyword extraction or subjective human judgment. As a technical effect, the analysis unit enables extraction of highly relevant topics in line with the user's current location and regional trends, improving the suitability, naturalness, and user satisfaction of conversation generation. Application fields include conversation support applications, regional information recommendation, automated tourist guides, and customer support automation.

The analysis unit can analyze the user's social media activity during analysis and extract and analyze related topics. For example, the analysis unit uses social media posts to analyze the user's social media activity. For example, the analysis unit analyzes topics frequently mentioned by the user on social media and extracts related topics. The analysis unit can also reflect topics of interest to the user's followers or friends on social media in the analysis. For example, the analysis unit analyzes topics of interest to the user's followers or friends on social media and extracts related topics. Furthermore, the analysis unit can analyze the user's social media activity history and extract related topics. For example, the analysis unit analyzes the user's past social media posts and extracts related topics. Thus, by analyzing the user's social media activity, the analysis unit can extract related topics and reflect them in the analysis. Specifically, the analysis unit accepts as input structured data obtained from the user's social media account, such as post data (e.g., latest 100 post texts, UTF-8, up to 256 tokens), like history, follow relationships, and friend lists. The analysis unit uses natural language processing algorithms (e.g., BERT-based topic classifier, TF-IDF scoring) to calculate frequent keywords and topic distributions and identify topics frequently mentioned by the user. Furthermore, the analysis unit analyzes post data from the user's followers or friends and extracts topics of high interest across the network. For example, input example 1 “the user frequently posts about sports,” input example 2 “friends frequently post about travel,” input example 3 “the user has recently shown interest in music events”—the analysis unit extracts related topics such as “sports,” “travel,” and “music events” in each case. The analysis unit prioritizes extraction of information related to these topics and structures the data for input to the generation unit. The analysis unit calculates interest scores (0.0 to 1.0) and network relevance scores for each topic and uses filtering algorithms (e.g., extracting only the top N scores, threshold setting) to extract only highly relevant topics. By combining these processes with multimodal data integration and rule-based processing in high-dimensional feature space, the analysis unit greatly improves real-time performance, diversity, and personalization accuracy, unlike conventional simple keyword extraction or subjective human judgment. As a technical effect, the analysis unit enables extraction of highly relevant topics in line with the user's social media activity and overall network interests, improving the suitability, naturalness, and user satisfaction of conversation generation. Application fields include conversation support applications, personalized news recommendation, current event conversation practice in education, and customer support automation.

The generation unit can estimate the user's emotion and adjust the expression method of small talk based on the estimated emotion of the user. For example, the generation unit uses facial recognition technology to estimate the user's emotion. For example, the generation unit captures the user's facial expression with a camera and estimates the user's emotion using a facial recognition algorithm. The generation unit can also estimate the user's emotion using voice analysis technology. For example, the generation unit analyzes the tone and speed of the user's voice to estimate the user's emotion. Furthermore, the generation unit can estimate the user's emotion using text analysis technology. For example, the generation unit analyzes the content and context of text input by the user to estimate the user's emotion. The generation unit adjusts the expression method of small talk based on the estimated emotion of the user. For example, if the user is relaxed, the generation unit allows the generation AI to use casual and friendly expressions. If the user is nervous, the generation unit allows the generation AI to use polite and calm expressions. Furthermore, if the user is excited, the generation unit allows the generation AI to use lively expressions. Thus, by adjusting the expression method of small talk based on the user's emotion, the generation unit can provide more appropriate expression methods. Emotion estimation is realized using, for example, an emotion engine or emotion estimation function of the generation AI. The generation AI may be a text generation AI (such as an LLM) or a multimodal generation AI, but is not limited to such examples. Specifically, the generation unit integratively processes multiple input modalities for user emotion estimation. For facial recognition, the generation unit inputs image data obtained from a camera (e.g., 640×480 pixel RGB images, 5 frames per second) to a CNN-based facial classification model (e.g., ResNet50 plus Softmax output layer) to estimate emotion labels such as “joy,” “sadness,” “surprise,” “anger,” and “relaxation.” For voice analysis, the generation unit inputs 16 kHz, 16 PCM audio waveform data (up to 30 seconds), extracts acoustic features (MFCC, pitch, energy), and outputs emotion scores (0.0 to 1.0) such as “calmness,” “nervousness,” and “excitement” using an RNN or Transformer-based voice emotion recognition model. For text analysis, the generation unit inputs natural language sentences (UTF-8, up to 512 tokens) entered by the user to a pre-trained language model such as BERT or RoBERTa, generates contextual embedding vectors (768 dimensions), and outputs emotion labels and probability distributions such as “positive,” “negative,” and “neutral” using an emotion classification head. For example, given input example 1 “I had a great time today” as text, input example 2 “audio with a trembling voice,” and input example 3 “image of a smiling face,” the generation unit estimates emotions such as “joy,” “nervousness,” and “relaxation,” respectively. The generation unit integrates emotion estimation results from multiple modalities using ensemble methods (e.g., weighted average, meta-classifier) to determine the final emotion label and score. The generation unit dynamically adjusts parameters of the small talk generation algorithm (e.g., tone, expression style, writing style, vocabulary selection) according to the estimated emotion. For example, in a relaxed state, casual vocabulary and friendly expressions are prioritized; in a nervous state, polite language and formal expressions are selected; in an excited state, lively vocabulary and exclamatory expressions are frequently used. The generation unit provides these adjustment results as prompts to a large-scale language model (e.g., Transformer architecture, with more than 1 billion pre-trained parameters) to generate natural conversational sentences. The generation unit generates structured data as output, including natural language text (UTF-8, up to 256 tokens), conversation labels (e.g., “casual,” “formal,” “energetic”), emotion compatibility scores (0.0 to 1.0), and passes them to the presentation unit. The generation unit applies grammar checking and redundancy removal algorithms (e.g., grammar error detection models, duplicate sentence removal rules) to the generated results to ensure the quality of the output sentences. The generation unit generates multiple candidate outputs (e.g., top N results by beam search) and selects the optimal small talk sentence based on emotion compatibility and diversity metrics (e.g., Distinct-n). Unlike conventional template-based or simple rule-based generation, these processes are realized by computer-specific technical methods such as multimodal data integration in high-dimensional feature space, dynamic parameter control, and rule-based expression adjustment, resulting in technical effects such as optimized generation of natural conversational sentences for each user, personalized conversation experience, and improved user satisfaction. Specific application fields include conversation support applications, emotion-adaptive educational support, mental healthcare support, customer support automation, and personalized communication tools.

The generation unit can set the level of detail of small talk during generation based on the importance of topics. For example, the generation unit uses the user's interest score to evaluate the importance of topics. For example, the generation unit determines that topics frequently mentioned by the user in past inputs are highly important. The generation unit can also evaluate the impact of topics by considering the influence of topics on other users. For example, the generation unit determines that topics of interest to many users are highly important. The generation unit adjusts the level of detail of small talk based on the importance of topics. For example, for important topics, the generation unit allows the generation AI to generate small talk including detailed explanations. For less important topics, the generation unit allows the generation AI to generate concise small talk. Furthermore, the generation unit sets the appropriate level of detail according to the importance of topics. Thus, by adjusting the level of detail of small talk based on the importance of topics, the generation unit can generate small talk with an appropriate level of detail. Specifically, the generation unit accepts as input structured data received from the analysis unit, such as importance scores for each topic (e.g., real values from 0.0 to 1.0), user interest scores, and topic social impact scores. The generation unit uses these scores to dynamically determine the level of detail parameters for small talk sentences generated for each topic (e.g., length of explanation, presence of specific examples, addition of supplementary information). For example, input example 1 “topics frequently mentioned by the user in the past (e.g., jogging)”—the generation unit generates small talk including detailed episodes and background explanations. Input example 2 “socially noteworthy topics (e.g., climate change)”—the generation unit supplements with related news or statistical information. Input example 3 “topics for which the user has shown little interest”—the generation unit generates concise one-sentence small talk. The generation unit uses prompt engineering techniques to provide instructions to a large-scale language model (e.g., Transformer architecture, with more than 1 billion pre-trained parameters), such as “This topic is highly important, so please explain in detail” or “Please summarize this topic concisely,” and inputs the data to the model. Within the model, the generation unit uses a self-attention mechanism to dynamically understand relationships and context among topics and generates conversational sentences with the optimal level of detail. The generation unit generates structured data as output, including natural language text (UTF-8, up to 256 tokens), detail level labels (e.g., “detailed,” “standard,” “concise”), and topic importance scores (0.0 to 1.0). The generation unit applies redundancy removal and information density optimization algorithms (e.g., duplicate sentence removal, summarization models) to the generated results to ensure the quality and information density of the output sentences. The generation unit generates multiple candidate outputs (e.g., top N results by beam search) and selects the optimal small talk sentence based on detail level and relevance metrics. Unlike conventional template-based or simple rule-based generation, these processes are realized by computer-specific technical methods such as dynamic detail level control in high-dimensional feature space, integration of user interest and social impact, and rule-based detail level adjustment, resulting in technical effects such as optimized generation of conversational sentences with appropriate information volume for each user, personalized conversation experience, and improved user satisfaction. Specific application fields include conversation support applications, educational conversation practice tools, personalized news summarization, and customer support automation.

The generation unit can use different generation algorithms during generation according to the category of topics. For example, the generation unit uses natural language processing technology to identify the category of topics. For example, if the topic input by the user is related to sports, the generation AI applies a sports-specific generation algorithm. If the topic input by the user is related to travel, the generation AI applies a travel-specific generation algorithm. Furthermore, if the topic input by the user is related to cooking, the generation AI applies a cooking-specific generation algorithm. The generation unit applies different generation algorithms according to the category of topics. For example, for topics related to sports, the generation unit applies a sports-specific generation algorithm to generate more appropriate small talk. For topics related to travel, the generation unit applies a travel-specific generation algorithm to generate more appropriate small talk. For topics related to cooking, the generation unit applies a cooking-specific generation algorithm to generate more appropriate small talk. Thus, by applying different generation algorithms according to the category of topics, the generation unit can generate more appropriate small talk. Specifically, the generation unit accepts as input category labels for each topic received from the analysis unit (e.g., “sports,” “travel,” “cooking,” “music,” “news,” etc.). The generation unit maintains a set of optimized generation algorithms for each category (e.g., sports uses a sports terminology dictionary and case dataset; travel uses a place and tourist spot database; cooking uses a recipe database and ingredient knowledge base) and selects the appropriate generation algorithm according to the category of the input topic. For example, input example 1 “soccer match” as a topic—the generation unit applies a sports-specific generation algorithm (e.g., template reflecting the flow and terminology of sports events plus a large-scale language model) and generates small talk such as “Yesterday's soccer match was very exciting. Which team do you support?” Input example 2 “Kyoto trip” as a topic—the generation unit applies a travel-specific generation algorithm (e.g., tourist spot information database plus large-scale language model) and generates small talk such as “I visited Kyoto last weekend. The autumn leaves at Kiyomizu Temple were very beautiful.” Input example 3 “pasta dish” as a topic—the generation unit applies a cooking-specific generation algorithm (e.g., recipe knowledge base plus large-scale language model) and generates small talk such as “I've been into making pasta at home lately. Do you have any recommended recipes?” The generation unit applies different vocabulary selection rules, writing styles, and information supplementation algorithms for each category (e.g., sports includes scores and player names; travel includes place names and experiences; cooking includes ingredients and cooking methods) to enhance the naturalness and suitability of conversational sentences. The generation unit generates structured data as output, including natural language text (UTF-8, up to 256 tokens), category labels, and relevance scores (0.0 to 1.0). The generation unit applies category compatibility evaluation and redundancy removal algorithms to the generated results to ensure the quality of the output sentences. Unlike conventional generic template generation or simple rule-based generation, these processes are realized by computer-specific technical methods such as dynamic generation control in high-dimensional feature space combining category-specific expertise, databases, and algorithms, resulting in technical effects such as improved category compatibility, naturalness, diversity, and user satisfaction in conversation. Specific application fields include conversation support applications, personalized educational support, customer support automation, and conversation practice tools for specialized fields.

The generation unit can adjust the length of small talk during generation based on the estimated emotion of the user. For example, the generation unit uses facial recognition technology to estimate the user's emotion. For example, the generation unit captures the user's facial expression with a camera and estimates the user's emotion using a facial recognition algorithm. The generation unit can also estimate the user's emotion using voice analysis technology. For example, the generation unit analyzes the tone and speed of the user's voice to estimate the user's emotion. Furthermore, the generation unit can estimate the user's emotion using text analysis technology. For example, the generation unit analyzes the content and context of text input by the user to estimate the user's emotion. The generation unit adjusts the length of small talk based on the estimated emotion of the user. For example, if the user is relaxed, the generation unit allows the generation AI to generate longer small talk. If the user is nervous, the generation unit allows the generation AI to generate shorter small talk. Furthermore, if the user is excited, the generation unit allows the generation AI to generate small talk of moderate length. Thus, by adjusting the length of small talk based on the user's emotion, the generation unit can provide small talk of appropriate length. Emotion estimation is realized using, for example, an emotion engine or emotion estimation function of the generation AI. The generation AI may be a text generation AI (such as an LLM) or a multimodal generation AI, but is not limited to such examples. Specifically, the generation unit integratively processes multiple input modalities (facial images, audio waveforms, text sentences) for user emotion estimation. For facial recognition, the generation unit inputs camera images (e.g., 640×480 pixel RGB images, 5 frames per second) to a CNN-based facial classification model (e.g., ResNet50 plus Softmax) to estimate emotion labels such as “relaxation,” “nervousness,” and “excitement.” For voice analysis, the generation unit extracts features such as MFCC and pitch from 16 kHz, 16 bit PCM audio waveforms and outputs emotion scores (0.0 to 1.0) using an RNN or Transformer-based voice emotion recognition model. For text analysis, the generation unit inputs natural language sentences (UTF-8, up to 512 tokens) to a pre-trained model such as BERT or RoBERTa and outputs emotion labels and probability distributions using an emotion classification head. For example, given input example 1 “I had a great time today” as text, input example 2 “audio with a trembling voice,” and input example 3 “image of a smiling face,” the generation unit estimates emotions such as “relaxation,” “nervousness,” and “excitement,” respectively. The generation unit integrates these emotion estimation results using ensemble methods to determine the final emotion label and score. The generation unit dynamically adjusts length control parameters of the small talk generation algorithm (e.g., maximum token count, number of sentences, level of detail) according to the estimated emotion. For example, in a relaxed state, the maximum token count is increased and long sentences including detailed episodes and supplementary information are generated; in a nervous state, the maximum token count is decreased and concise one-sentence small talk is generated; in an excited state, small talk of moderate length (e.g., 2-3 sentences) is generated. The generation unit uses prompt engineering techniques to provide instructions to a large-scale language model (e.g., Transformer architecture, with more than 1 billion pre-trained parameters), such as “Generate longer/shorter/moderate-length sentences according to this emotional state,” and inputs the data to the model. The generation unit generates structured data as output, including natural language text (UTF-8, up to 256 tokens), length labels (e.g., “long,” “short,” “standard”), and emotion compatibility scores (0.0 to 1.0). The generation unit applies length constraints and redundancy removal algorithms to the generated results to ensure the quality and information density of the output sentences. Unlike conventional template-based or simple rule-based generation, these processes are realized by computer-specific technical methods such as multimodal data integration in high-dimensional feature space, dynamic length control, and rule-based generation adjustment, resulting in technical effects such as optimized length control of conversational sentences for each user, personalized conversation experience, and improved user satisfaction. Specific application fields include conversation support applications, emotion-adaptive educational support, mental healthcare support, and customer support automation.

The generation unit can set the priority of small talk during generation based on the submission timing of topics. For example, the generation unit uses submission date and time to consider the timing of topic submission. For example, the generation unit records the date and time when the user submitted a topic and prioritizes generation of recently submitted topics. The generation unit can also consider submission frequency. For example, the generation unit prioritizes generation of topics that the user submits frequently. Furthermore, the generation unit sets appropriate priority according to the timing of submission by the generation AI. For example, the generation unit postpones topics with older submission dates. Thus, by determining the priority of small talk based on the timing of topic submission, the generation unit can generate small talk in an appropriate order. Specifically, the generation unit accepts as input submission date and time information for each topic received from the analysis unit (e.g., ISO8601 format timestamp, e.g., 2024-06-01T10:15:00Z), submission frequency count (e.g., number of submissions in the past 30 days), and a topic submission history database for each user (e.g., up to 1,000 topic IDs plus submission date and time plus submission count). The generation unit uses this information to assign priority scores to each topic (e.g., score based on recency of submission date from 0.0 to 1.0, score based on submission frequency from 0.0 to 1.0). The generation unit applies statistical methods such as time-series weighting algorithms (e.g., exponential moving average, increased weighting for recent submissions) and frequency normalization (e.g., Z-score normalization) to calculate priority scores. For example, input example 1 “Topic A submitted on 2024Jun. 1,” “Topic B submitted on 2024May 20,” “Topic C submitted on 2024Jun. 2 (submitted 5 times)”—the generation unit prioritizes Topic C, then Topic A, and finally Topic B in the priority list input to the generation AI. The generation unit provides the prioritized topic list as a prompt to a large-scale language model (e.g., Transformer architecture, with more than 1 billion pre-trained parameters), with instructions such as “Generate small talk sentences in this order.” Within the model, the generation unit uses a self-attention mechanism to dynamically control topic development according to priority and generate natural conversational sentences. The generation unit generates structured data as output, including natural language text (UTF-8, up to 256 tokens), priority labels (e.g., “highest priority,” “normal,” “postponed”), and topic ID list. The generation unit applies priority compatibility evaluation and redundancy removal algorithms (e.g., duplicate topic elimination) to the generated results to ensure the quality and validity of the output sentences and order. Unlike conventional simple time-series reference or reliance on human memory, these processes are realized by computer-specific technical methods such as time-series data integration in high-dimensional feature space, statistical prioritization, and rule-based order control, resulting in technical effects such as optimized conversation order control for each user, personalized conversation experience, and improved user satisfaction. Specific application fields include conversation support applications, personalized educational support, customer support automation, and time-series event summarization.

The generation unit can set the order of small talk during generation based on the relevance of topics. For example, the generation unit uses common keywords to evaluate the relevance of topics. For example, the generation unit prioritizes generation of topics with common keywords among those input by the user. The generation unit can also evaluate contextual similarity. For example, the generation unit analyzes the context of topics input by the user and prioritizes generation of highly relevant topics. Furthermore, the generation unit sets the appropriate order according to the relevance of topics by the generation AI. For example, the generation unit prioritizes generation of highly relevant topics and postpones less relevant topics. Thus, by adjusting the order of small talk based on the relevance of topics, the generation unit can provide small talk in an appropriate order. Specifically, the generation unit accepts as input keyword lists for each topic received from the analysis unit (e.g., up to 10 main keywords per topic), contextual embedding vectors (e.g., BERT embedding vectors, 768 dimensions), and topic relevance score matrices (e.g., cosine similarity from 0.0 to 1.0). The generation unit applies natural language processing algorithms such as keyword co-occurrence frequency, similarity between contextual vectors, and topic clustering (e.g., K-means, hierarchical clustering) to calculate relevance scores. For example, input example 1 “jogging,” “park,” “weather” as topics—the generation unit determines that “jogging” and “park” are highly relevant and generates them consecutively, placing “weather” afterward. Input example 2 “travel,” “cooking,” “music”—the generation unit generates the highly relevant “travel” and “cooking” first and postpones “music.” The generation unit provides the top relevance score topics as a prioritized list to a large-scale language model (e.g., Transformer architecture) as a prompt, with instructions such as “Generate small talk sentences in this order.” Within the model, the generation unit uses a self-attention mechanism to dynamically understand topic relevance and realize a natural conversational flow. The generation unit generates structured data as output, including natural language text (UTF-8, up to 256 tokens), order labels (e.g., “high relevance,” “medium relevance,” “low relevance”), and topic ID list. The generation unit applies relevance compatibility evaluation and redundancy removal algorithms (e.g., duplicate topic elimination) to the generated results to ensure the quality and validity of the output sentences and order. Unlike conventional simple keyword rearrangement or subjective human judgment, these processes are realized by computer-specific technical methods such as contextual similarity calculation, clustering, and rule-based order control in high-dimensional feature space, resulting in technical effects such as improved naturalness, consistency, and user satisfaction in conversation. Specific application fields include conversation support applications, educational conversation practice tools, customer support automation, and topic summary generation.

The presentation unit can estimate the user's emotion and adjust the presentation method of small talk based on the estimated emotion of the user. For example, the presentation unit uses facial recognition technology to estimate the user's emotion. For example, the presentation unit captures the user's facial expression with a camera and estimates the user's emotion using a facial recognition algorithm. The presentation unit can also estimate the user's emotion using voice analysis technology. For example, the presentation unit analyzes the tone and speed of the user's voice to estimate the user's emotion. Furthermore, the presentation unit can estimate the user's emotion using text analysis technology. For example, the presentation unit analyzes the content and context of text input by the user to estimate the user's emotion. The presentation unit adjusts the presentation method of small talk based on the estimated emotion of the user. For example, if the user is relaxed, the presentation unit allows the generation AI to use a casual presentation method. If the user is nervous, the presentation unit allows the generation AI to use a polite presentation method. Furthermore, if the user is excited, the presentation unit allows the generation AI to use a lively presentation method. Thus, by adjusting the presentation method of small talk based on the user's emotion, the presentation unit can provide an appropriate presentation method. Emotion estimation is realized using, for example, an emotion engine or emotion estimation function of the generation AI. The generation AI may be a text generation AI (such as an LLM) or a multimodal generation AI, but is not limited to such examples. Specifically, the presentation unit integratively processes multiple input modalities (facial images, audio waveforms, text sentences) for user emotion estimation. For facial recognition, the presentation unit inputs image data obtained from a camera (e.g., 640×480 pixel RGB images, 5 frames per second) to a CNN-based facial classification model (e.g., ResNet50 plus Softmax output layer) to estimate emotion labels such as “joy,” “sadness,” “surprise,” “anger,” and “relaxation.” For voice analysis, the presentation unit inputs 16 kHz, 16 PCM audio waveform data (up to 30 seconds), extracts acoustic features (MFCC, pitch, energy), and outputs emotion scores (0.0 to 1.0) such as “calmness,” “nervousness,” and “excitement” using an RNN or Transformer-based voice emotion recognition model. For text analysis, the presentation unit inputs natural language sentences (UTF-8, up to 512 tokens) entered by the user to a pre-trained language model such as BERT or RoBERTa, generates contextual embedding vectors (768 dimensions), and outputs emotion labels and probability distributions such as “positive,” “negative,” and “neutral” using an emotion classification head. For example, given input example 1 “I had a great time today” as text, input example 2 “audio with a trembling voice,” and input example 3 “image of a smiling face,” the presentation unit estimates emotions such as “joy,” “nervousness,” and “relaxation,” respectively. The presentation unit integrates emotion estimation results from multiple modalities using ensemble methods (e.g., weighted average, meta-classifier) to determine the final emotion label and score. The presentation unit dynamically selects the presentation method control algorithm (e.g., text display, audio playback, notification format, color, font, animation effects) according to the estimated emotion. For example, in a relaxed state, casual colors and animation are used for display; in a nervous state, calm colors and polite speech synthesis are used; in an excited state, bright colors and dynamic effects are applied. The presentation unit generates structured data as output, including presentation method labels (e.g., “casual,” “formal,” “energetic”), emotion compatibility scores (0.0 to 1.0), and presentation content (text, audio, notification format), and reflects them in the user interface. Unlike conventional simple text display or audio playback, these processes are realized by computer-specific technical methods such as multimodal emotion estimation in high-dimensional feature space, dynamic presentation method control, and rule-based expression adjustment, resulting in technical effects such as optimized presentation experience for each user, personalized conversation support, and improved user satisfaction. Specific application fields include conversation support applications, emotion-adaptive educational support, mental healthcare support, customer support automation, and personalized communication tools.

The presentation unit can refer to the user's past reaction history during presentation and select an appropriate presentation method. For example, the presentation unit uses user feedback to refer to the user's past reaction history. For example, the presentation unit prioritizes presentation methods that have previously received positive reactions from the user. The presentation unit can also use reaction logs to select the optimal presentation method. For example, the presentation unit analyzes the user's past reaction logs and selects the optimal presentation method. Furthermore, the presentation unit can analyze the user's past reaction history and propose an appropriate presentation method. For example, the presentation unit proposes an appropriate presentation method based on the user's past reaction history. Thus, by referring to the user's past reaction history, the presentation unit can select and provide the optimal presentation method to the user. Specifically, the presentation unit accepts as input a reaction history database accumulated for each user (e.g., presentation method ID, presentation date and time, user reaction label “positive,” “neutral,” “negative,” reaction intensity score 0.0 to 1.0, up to 1,000 entries). The presentation unit applies algorithms such as time-series analysis (e.g., correspondence between the last 30 presentation methods and reactions), clustering (e.g., clustering of reaction tendencies by presentation method), and weighted averaging of feedback intensity to reaction history. For example, input example 1 “many positive reactions to audio presentation in the past,” input example 2 “many negative reactions to text display,” input example 3 “many neutral reactions to notification format”—the presentation unit prioritizes audio presentation, avoids text display, and selects notification format depending on the situation. The presentation unit calculates an optimal presentation method score (0.0 to 1.0) from reaction history and uses a presentation method selection algorithm (e.g., random selection from the top N scores, situation-dependent rule application) to determine the optimal presentation method. The presentation unit generates structured data as output, including presentation method labels (e.g., “audio,” “text,” “notification”), selection reason (e.g., “based on past positive reactions”), and reaction prediction score, and reflects them in the user interface. Unlike conventional simple history reference or reliance on human memory, these processes are realized by computer-specific technical methods such as time-series history analysis in high-dimensional feature space, reaction tendency clustering, and rule-based presentation method selection, resulting in technical effects such as optimized presentation experience for each user, personalized conversation support, and improved user satisfaction. Specific application fields include conversation support applications, personalized educational support, customer support automation, and user-adaptive interface design.

The presentation unit can estimate the user's emotion and adjust the order of presenting small talk based on the estimated emotion of the user. For example, the presentation unit uses facial recognition technology to estimate the user's emotion. Specifically, the presentation unit captures the user's facial expression with a camera and estimates the user's emotion using a facial recognition algorithm. Additionally, the presentation unit can estimate the user's emotion using voice analysis technology. For example, the presentation unit analyzes the tone and speed of the user's voice to estimate the user's emotion. Furthermore, the presentation unit can estimate the user's emotion using text analysis technology. For example, the presentation unit analyzes the content and context of text input by the user to estimate the user's emotion. The presentation unit adjusts the order of presenting small talk based on the estimated emotion of the user. For instance, if the user is relaxed, the presentation unit causes the generation AI to present in a casual order. If the user is tense, the presentation unit causes the generation AI to present in a polite order. If the user is excited, the presentation unit causes the generation AI to present in an energetic order. Thus, by adjusting the order of presenting small talk based on the user's emotion, the presentation unit can provide small talk in an appropriate order. Emotion estimation is realized, for example, by using an emotion engine or a generation AI with emotion estimation functionality. The generation AI may be a text generation AI (e.g., LLM) or a multimodal generation AI, but is not limited to these examples. Specifically, the presentation unit integrally processes multiple input modalities (facial images, voice waveforms, text sentences) for user emotion estimation. In facial recognition, the presentation unit inputs image data obtained from a camera (e.g., 640×480 pixel RGB images, 5 frames per second) into a convolutional neural network (CNN)-based facial classification model (e.g., ResNet50 +Softmax output layer) to estimate emotion labels such as “relaxed,” “tense,” or “excited.” In voice analysis, the presentation unit inputs 16 kHz, 16 PCM voice waveform data (up to 30 seconds), extracts acoustic features (MFCC, pitch, energy), and outputs emotion scores (0.0-1.0) using a recurrent neural network (RNN) or Transformer-based voice emotion recognition model. In text analysis, the presentation unit inputs natural language sentences (UTF-8, up to 512 tokens) entered by the user into a pre-trained language model such as BERT or RoBERTa, generates context embedding vectors (dimension 768), and outputs emotion labels and probability distributions such as “relaxed,” “tense,” or “excited” using an emotion classification head. For example, given input example 1:“I had a great time today” (text), input example 2:“voice trembling” (audio), and input example 3:“smiling facial image,” the presentation unit estimates emotions such as “relaxed,” “tense,” or “excited” respectively. The presentation unit integrates emotion estimation results from these multiple modalities using ensemble methods (e.g., weighted average, meta-classifier) to determine the final emotion label and score. The presentation unit dynamically applies a presentation order control algorithm according to the estimated emotion (e.g., casual topics first when relaxed, polite topics first when tense, energetic topics first when excited). The presentation unit generates structured data such as presentation order labels (e.g., “casual priority,” “polite priority,” “energetic priority”), emotion fit scores (0.0-1.0), and presentation content lists, and reflects them in the user interface. These processes are realized by computer-specific technical methods such as multimodal emotion estimation in high-dimensional feature space, dynamic order control, and rule-based presentation order adjustment, which differ from conventional simple order presentation or subjective human judgment, thereby providing technical effects such as optimized presentation order control for each user, personalized conversation support, and improved user satisfaction. Specific application fields include conversation support applications, emotion-adaptive educational support, mental healthcare support, and customer support automation.

The presentation unit can select an appropriate presentation method by considering the user's device information at the time of presentation. For example, the presentation unit uses the type of device to obtain the user's device information. If the user is using a smartphone, the presentation unit provides a presentation method optimized for the screen size. If the user is using a tablet, the presentation unit can provide a presentation method optimized for a larger screen. Furthermore, if the user is using a smartwatch, the presentation unit can provide a concise and highly visible presentation method. The presentation unit selects the optimal presentation method by considering the user's device information. For example, the presentation unit considers the type of device and OS version to provide the optimal presentation method. Thus, by considering the user's device information, the presentation unit can provide the optimal presentation method. Specifically, the presentation unit accepts the user's device information (e.g., device type “smartphone,” “tablet,” “smartwatch,” “PC,” screen resolution, OS version, active application) as input. Based on the device information, the presentation unit applies a presentation method selection algorithm (e.g., layout optimization according to screen size, UI component selection depending on OS version, determination of notification API availability). For example, for input example 1:“smartphone (1080×1920 pixels),” the presentation unit selects a text display or audio playback UI optimized for a vertically long screen. For input example 2:“tablet (2048×1536 pixels),” the presentation unit provides multi-column display or detailed information panels optimized for a large screen. For input example 3: “smartwatch (320××320 pixels),” the presentation unit selects concise text and notification display with large buttons. The presentation unit generates structured data such as presentation method labels optimized for each device information (e.g., “smartphone optimized,” “tablet optimized,” “watch optimized”), layout parameters, and notification formats, and reflects them in the user interface. The presentation unit can also detect changes in the user's device environment (e.g., screen rotation, OS update) in real time and dynamically switch the presentation method. These processes are realized by computer-specific technical methods such as device information integration in high-dimensional feature space, dynamic layout control, and rule-based presentation method selection, which differ from conventional simple text display or fixed UI, thereby providing technical effects such as optimized presentation experience for each user, personalized conversation support, and improved user satisfaction. Specific application fields include conversation support applications, multi-device compatible educational support, customer support automation, and communication tools for wearable devices.

The system according to the embodiment is not limited to the examples described above and can be variously modified as follows. Specifically, the system allows diverse variations in the module configuration of the analysis unit, generation unit, and presentation unit, the architecture of AI models, data flow, input/output specifications, and parameter control methods. For example, the analysis unit may employ lightweight and high-speed models such as DistilBERT or XLNet, in addition to BERT or RoBERTa as natural language processing models. The generation unit may use large-scale language models based on RNN or encoder-decoder architectures, in addition to Transformer architectures. The presentation unit may combine the latest speech synthesis models such as FastSpeech or VITS, in addition to Tacotron2 +WaveNet as speech synthesis engines. Furthermore, various implementation forms can be adopted for the cooperation method among units, such as cloud distributed processing, on-device inference on edge devices, and parallel computation using GPU clusters. Regarding data input/output, the system can handle video data or sensor data (e.g., acceleration, heart rate) as input, in addition to text, voice, and images, thereby extending multimodal analysis and generation. Advanced learning methods such as transfer learning, self-supervised learning, reinforcement learning, and federated learning can also be introduced for AI model training. With these diverse modifications and extensions, the system can flexibly design the optimal configuration and processing flow according to specific use cases, user attributes, and usage environments, thereby achieving technical effects such as optimization of processing speed, accuracy, scalability, operational cost, and degree of personalization. Specific application fields include conversation support applications, educational conversation practice tools, multimodal communication support, dialogue support in medical and welfare fields, and IoT-linked services.

The analysis unit can estimate the user's interests and concerns based on the user's input and enhance the accuracy of analysis based on the estimated interests and concerns. For example, the analysis unit analyzes keywords and phrases frequently input by the user to identify the user's interests and concerns. The analysis unit can also analyze the user's past input history to identify topics of interest to the user. Furthermore, the analysis unit can analyze the user's social media activity to estimate the user's interests and concerns. Thus, by enhancing the accuracy of analysis based on the user's interests and concerns, the analysis unit can obtain more appropriate analysis results. Specifically, the analysis unit accepts as input text data entered by the user (e.g., UTF-8 encoded natural language sentences, up to 512 tokens), voice data (e.g., 16 kHz, 16 PCM waveform, up to 30 seconds), image data (e.g., 224×224 pixel RGB images), and social media post data (e.g., latest 100 post texts, UTF-8, up to 256 tokens). The analysis unit applies morphological analysis and named entity extraction algorithms (e.g., BERT-based, CRF-based) to text data to extract frequent keywords and phrases. Voice data is converted to text by extracting acoustic features (MFCC, spectrogram) and using a deep neural network-based speech recognition model (e.g., CTC-based), and similar natural language processing is applied. For image data, features are extracted using a convolutional neural network (CNN), and text is generated using an image captioning model (e.g., Image Captioning Transformer), which is then integrated with text analysis. The analysis unit manages the user's past input history database (e.g., text logs, voice logs, image logs) in chronological order and uses topic modeling (e.g., LDA, BERTopic), clustering (e.g., K-means), and autoregressive models (e.g., LSTM) to extract topics of interest and behavioral trends. For social media activity, structured data such as post texts, like history, and follow relationships are analyzed using natural language processing algorithms (e.g., BERT-based topic classifier, TF-IDF scoring) to identify topics frequently mentioned by the user and topics with high interest across the network. The analysis unit integrates analysis results from these multiple modalities in high-dimensional feature space and calculates an interest/concern score (0.0-1.0) for each user. For example, if the user frequently inputs keywords such as “jogging,” “park,” and “weather” in the past, the analysis unit extracts these as major topics of interest. If there are many travel-related posts on social media, the analysis unit identifies “travel” as a topic of interest. If there are many health-related topics in weekly voice input, the analysis unit extracts “health” as a topic of interest. Based on the estimated interest/concern score, the analysis unit dynamically adjusts parameters of subsequent feature extraction and topic extraction algorithms (e.g., number of clusters, thresholds, number of extracted topics) and personalizes input data for the generation unit. These processes are realized by computer-specific technical methods such as multimodal data integration in high-dimensional feature space, rule-based processing, and dynamic parameter control, which differ from conventional simple keyword extraction or subjective human judgment, thereby providing technical effects such as improved accuracy of interest/concern estimation for each user, personalized conversation generation, and optimization of user experience. Specific application fields include conversation support applications, personalized educational support, customer support automation, mental healthcare support, and personalized news recommendation.

The generation unit can estimate the user's preferences and style based on the user's input and generate small talk based on the estimated preferences and style. For example, the generation unit analyzes the style of small talk previously input by the user to identify the user's preferences and style. The generation unit can also analyze the user's social media activity to estimate the user's preferences and style. Furthermore, the generation unit can analyze the user's past input history to identify the user's preferences and style. Thus, by generating small talk based on the user's preferences and style, the generation unit can provide more appropriate small talk. Specifically, the generation unit accepts as input the user's past small talk history received from the analysis unit (e.g., natural language text, up to 1,000 entries), social media post data (e.g., latest 100 post texts, UTF-8, up to 256 tokens), and user input (e.g., text, voice, topic list derived from images). The generation unit applies natural language processing algorithms (e.g., BERT-based style classifier, TF-IDF scoring, clustering) to these data to extract the user's preferred expression style (e.g., casual, formal, humorous, concise, detailed), vocabulary tendencies, and style patterns. The generation unit also analyzes vocabulary and expressions frequently used by the user and the tone of posts (e.g., positive, negative, neutral) from social media activity to calculate preference and style scores (0.0-1.0). For example, if the user has frequently input casual expressions in past small talk, the generation unit prioritizes a casual style. If there are many humorous posts on social media, the generation unit selects humorous expressions. If the user tends to prefer detailed explanations in past history, the generation unit generates detailed small talk. Based on this preference and style information, the generation unit adds instructions such as “generate in a casual style” or “include detailed explanations” as prompts to a large-scale language model (e.g., Transformer architecture, more than 1 billion pre-trained parameters) and inputs the data to the model. The generation unit uses a self-attention mechanism within the model to generate natural conversation sentences optimized for the user's preferences and style. The generation unit generates structured data such as natural language text (UTF-8, up to 256 tokens), style labels (e.g., “casual,” “formal,” “humorous,” “detailed”), and style fit scores (0.0-1.0) as output and passes them to the presentation unit. The generation unit applies style fit evaluation and redundancy removal algorithms (e.g., duplicate sentence removal, summarization model) to the generated results to ensure the quality and user fit of the output sentences. These processes are realized by computer-specific technical methods such as user style estimation in high-dimensional feature space, dynamic generation control, and rule-based expression adjustment, which differ from conventional template-based or simple rule-based generation, thereby providing technical effects such as generation of natural conversation sentences optimized for each user, personalized conversation experience, and improved user satisfaction. Specific application fields include conversation support applications, personalized educational support, customer support automation, and personalized communication tools.

The presentation unit can estimate the user's preferences and style based on the user's input and present small talk based on the estimated preferences and style. For example, the presentation unit analyzes the style of small talk previously input by the user to identify the user's preferences and style. The presentation unit can also analyze the user's social media activity to estimate the user's preferences and style. Furthermore, the presentation unit can analyze the user's past input history to identify the user's preferences and style. Thus, by presenting small talk based on the user's preferences and style, the presentation unit can provide more appropriate small talk. Specifically, the presentation unit accepts as input small talk sentences received from the generation unit (natural language text, up to 256 tokens), style labels (e.g., “casual,” “formal,” “humorous,” “detailed”), style fit scores (0.0-1.0) as structured data, and the user's past reaction history database (e.g., presentation method ID, presentation date/time, user reaction label, reaction intensity score, up to 1,000 entries). The presentation unit analyzes the presentation methods and styles (e.g., voice presentation, text display, notification format, color, font, animation effects) to which the user has shown favorable reactions in the past using time-series analysis and clustering (e.g., clustering of reaction tendencies by presentation method) to select the optimal presentation method. The presentation unit also extracts expressions and presentation styles preferred by the user from social media activity and applies a presentation method selection algorithm (e.g., random selection from top N scores, application of context-dependent rules). For example, if the user has shown many favorable reactions to voice presentation in the past, the presentation unit prioritizes voice presentation. If the user has shown many favorable reactions to casual text display, the presentation unit selects display using casual colors or animation. If the user has shown neutral reactions to notification format, the presentation unit selects notification format according to the situation. The presentation unit generates structured data such as presentation method labels (e.g., “voice,” “text,” “notification,” “casual,” “formal”), selection reasons (e.g., “based on past favorable reactions”), and style fit scores as output and reflects them in the user interface. The presentation unit can also respond to changes in the user's device information (e.g., device type, screen size, OS version) and usage environment, and dynamically switch the optimal presentation method. These processes are realized by computer-specific technical methods such as user style estimation in high-dimensional feature space, reaction history analysis, and dynamic presentation method control, which differ from conventional simple text display or voice playback, thereby providing technical effects such as optimized presentation experience for each user, personalized conversation support, and improved user satisfaction. Specific application fields include conversation support applications, personalized educational support, customer support automation, and user-adaptive interface design.

The analysis unit can estimate the user's current mood and physical condition based on the user's input and enhance the accuracy of analysis based on the estimated mood and physical condition. For example, the analysis unit analyzes the content and context of text input by the user to estimate the user's mood and physical condition. The analysis unit can also analyze the user's voice input and estimate the user's mood and physical condition from the tone and speed of the user's voice. Furthermore, the analysis unit can analyze the user's facial expression to estimate the user's mood and physical condition. Thus, by enhancing the accuracy of analysis based on the user's mood and physical condition, the analysis unit can obtain more appropriate analysis results. Specifically, the analysis unit accepts as input natural language text entered by the user (UTF-8, up to 512 tokens), voice data (16 kHz, 16 PCM waveform, up to 30 seconds), and facial images (640×480 pixel RGB images, 5 frames per second). The analysis unit uses pre-trained language models such as BERT or RoBERTa for text data to generate context embedding vectors (dimension 768) and outputs labels and probability distributions such as “positive,” “negative,” “neutral,” “fatigue,” and “vitality” using an emotion/condition classification head. For voice data, the analysis unit extracts acoustic features (MFCC, pitch, energy) and outputs scores (0.0-1.0) for “calmness,” “tension,” “fatigue,” and “vitality” using RNN or Transformer-based voice emotion/condition recognition models. For facial images, the analysis unit uses a CNN-based facial classification model (e.g., ResNet50 +Softmax output layer) to estimate emotion/condition labels such as “joy,” “sadness,” “surprise,” “anger,” “relaxation,” and “fatigue.” For example, given input example 1:“I am very tired today” (text), input example 2: “hoarse voice” (audio), and input example 3:“facial image with heavy-looking eyes,” the analysis unit estimates states such as “fatigue” or “decreased vitality” respectively. The analysis unit integrates estimation results from these multiple modalities using ensemble methods (e.g., weighted average, meta-classifier) to determine the final mood/condition label and score. According to the estimated mood/condition, the analysis unit dynamically adjusts parameters of subsequent feature extraction and topic extraction algorithms (e.g., number of clusters, thresholds, number of extracted topics) and personalizes input data for the generation unit. These processes are realized by computer-specific technical methods such as multimodal data integration in high-dimensional feature space, rule-based processing, and dynamic parameter control, which differ from conventional simple keyword extraction or subjective human judgment, thereby providing technical effects such as improved accuracy of mood/condition estimation for each user, personalized conversation generation, and optimization of user experience. Specific application fields include conversation support applications, mental healthcare support, health management support, and personalized educational support.

The generation unit can estimate the user's current mood and physical condition based on the user's input and generate small talk based on the estimated mood and physical condition. For example, the generation unit analyzes the content and context of text input by the user to estimate the user's mood and physical condition. The generation unit can also analyze the user's voice input and estimate the user's mood and physical condition from the tone and speed of the user's voice. Furthermore, the generation unit can analyze the user's facial expression to estimate the user's mood and physical condition. Thus, by generating small talk based on the user's mood and physical condition, the generation unit can provide more appropriate small talk. Specifically, the generation unit accepts as input mood/condition labels (e.g., “vitality,” “fatigue,” “relaxation,” “tension”), scores (0.0-1.0), and user input (text, voice, topic list derived from images) received from the analysis unit. Based on this information, the generation unit dynamically adjusts parameters of the small talk generation algorithm (e.g., tone, expression style, writing style, vocabulary selection, length). For example, if the user is in a fatigued state, the generation unit prioritizes expressions of encouragement or empathy and generates short, gentle-toned small talk. If the user is in a lively state, the generation unit generates small talk using energetic vocabulary and bright expressions. If the user is in a tense state, the generation unit selects polite and calm expressions. The generation unit adds prompts such as “generate according to this mood/condition” to a large-scale language model (e.g., Transformer architecture, more than 1 billion pre-trained parameters) and inputs the data to the model. The generation unit uses a self-attention mechanism within the model to generate natural conversation sentences optimized for the user's mood and physical condition. The generation unit generates structured data such as natural language text (UTF-8, up to 256 tokens), mood/condition fit scores (0.0-1.0), and expression style labels as output and passes them to the presentation unit. The generation unit applies mood/condition fit evaluation and redundancy removal algorithms (e.g., duplicate sentence removal, summarization model) to the generated results to ensure the quality and user fit of the output sentences. These processes are realized by computer-specific technical methods such as mood/condition estimation in high-dimensional feature space, dynamic generation control, and rule-based expression adjustment, which differ from conventional template-based or simple rule-based generation, thereby providing technical effects such as generation of natural conversation sentences optimized for each user, personalized conversation experience, and improved user satisfaction. Specific application fields include conversation support applications, mental healthcare support, health management support, and personalized educational support.

The presentation unit can estimate the user's current mood and physical condition based on the user's input and present small talk based on the estimated mood and physical condition. For example, the presentation unit analyzes the content and context of text input by the user to estimate the user's mood and physical condition. The presentation unit can also analyze the user's voice input and estimate the user's mood and physical condition from the tone and speed of the user's voice. Furthermore, the presentation unit can analyze the user's facial expression to estimate the user's mood and physical condition. Thus, by presenting small talk based on the user's mood and physical condition, the presentation unit can provide more appropriate small talk. Specifically, the presentation unit accepts as input small talk sentences received from the generation unit (natural language text, up to 256 tokens), mood/condition labels (e.g., “vitality,” “fatigue,” “relaxation,” “tension”), mood/condition fit scores (0.0-1.0) as structured data, and the user's past reaction history database (e.g., presentation method ID, presentation date/time, user reaction label, reaction intensity score, up to 1,000 entries). The presentation unit analyzes the presentation methods and styles (e.g., voice presentation, text display, notification format, color, font, animation effects) to which the user has shown favorable reactions in the past for each mood/condition state using time-series analysis and clustering to select the optimal presentation method. For example, if the user has shown many favorable reactions to voice presentation when fatigued, the presentation unit prioritizes voice presentation. If the user has shown many favorable reactions to casual text display when lively, the presentation unit selects display using casual colors or animation. The presentation unit generates structured data such as presentation method labels (e.g., “voice,” “text,” “notification”), mood/condition fit scores, and selection reasons as output and reflects them in the user interface. The presentation unit can also respond to changes in the user's device information and usage environment and dynamically switch the optimal presentation method. These processes are realized by computer-specific technical methods such as mood/condition estimation in high-dimensional feature space, reaction history analysis, and dynamic presentation method control, which differ from conventional simple text display or voice playback, thereby providing technical effects such as optimized presentation experience for each user, personalized conversation support, and improved user satisfaction. Specific application fields include conversation support applications, mental healthcare support, health management support, and user-adaptive interface design.

The analysis unit can analyze the user's past behavioral patterns based on the user's input and enhance the accuracy of analysis. For example, the analysis unit analyzes the content and context of text previously input by the user to identify behavioral patterns. The analysis unit can also analyze the user's past voice input to identify behavioral patterns. Furthermore, the analysis unit can analyze the user's past facial expressions to identify behavioral patterns. Thus, by enhancing the accuracy of analysis based on the user's past behavioral patterns, the analysis unit can obtain more appropriate analysis results. Specifically, the analysis unit manages an input history database accumulated chronologically for each user (e.g., text logs as UTF-8 natural language sentences, up to 1,000 entries; voice logs as 16 kHz, 16 bit PCM waveforms; image logs as 224×224 pixel RGB images; facial images as 640×480 pixel RGB images). The analysis unit applies morphological analysis, named entity extraction, topic modeling (e.g., LDA, BERTopic), clustering (e.g., K-means), and autoregressive models (e.g., LSTM) to text history to detect behavioral patterns and changes in interests. Voice history is converted to text using a speech recognition model (e.g., CTC-based), and similar natural language processing is applied. Facial expression history is analyzed using a CNN-based facial classification model to extract time-series emotion/condition labels, which are integrated with behavioral pattern analysis. For example, if the user inputs a specific topic at the same day and time every week, the analysis unit extracts a regular behavioral pattern. If the input content changes before and after a specific event, the analysis unit detects behavioral change patterns. If changes in physical condition are detected from voice and facial expression history, the analysis unit extracts health status change patterns. Based on these analysis results, the analysis unit optimizes parameters of the analysis algorithm (e.g., number of topics to extract, clustering threshold, feature selection) for each user and personalizes input data for the generation unit. These processes are realized by computer-specific technical methods such as time-series analysis in high-dimensional feature space, self-learning algorithms, and multimodal integration, which differ from conventional simple history reference or methods relying on human memory, thereby providing technical effects such as improved analysis accuracy for each user, increased diversity and novelty in conversation generation, and advanced personalization. Specific application fields include conversation support applications, personalized educational support, customer support automation, and health management support.

The generation unit can analyze the user's past behavioral patterns based on the user's input and generate small talk. For example, the generation unit analyzes the content and context of text previously input by the user to identify behavioral patterns. The generation unit can also analyze the user's past voice input to identify behavioral patterns. Furthermore, the generation unit can analyze the user's past facial expressions to identify behavioral patterns. Thus, by generating small talk based on the user's past behavioral patterns, the generation unit can provide more appropriate small talk. Specifically, the generation unit accepts as input behavioral pattern labels (e.g., “regular exercise,” “weekend outings,” “seasonal interest changes”), pattern scores (0.0-1.0), and user input (text, voice, topic list derived from images) received from the analysis unit. Based on this information, the generation unit dynamically adjusts parameters of the small talk generation algorithm (e.g., tone, expression style, writing style, vocabulary selection, length). For example, if the user inputs topics about jogging every week, the generation unit generates small talk such as “Did you go jogging again this week?” to accompany regular behavior. If the user's interests change with the seasons, the generation unit generates small talk such as “Recently, there have been more spring-related topics.” The generation unit adds prompts such as “generate according to this behavioral pattern” to a large-scale language model (e.g., Transformer architecture, more than 1 billion pre-trained parameters) and inputs the data to the model. The generation unit uses a self-attention mechanism within the model to generate natural conversation sentences optimized for behavioral patterns. The generation unit generates structured data such as natural language text (UTF-8, up to 256 tokens), behavioral pattern fit scores (0.0-1.0), and expression style labels as output and passes them to the presentation unit. The generation unit applies behavioral pattern fit evaluation and redundancy removal algorithms (e.g., duplicate sentence removal, summarization model) to the generated results to ensure the quality and user fit of the output sentences. These processes are realized by computer-specific technical methods such as behavioral pattern estimation in high-dimensional feature space, dynamic generation control, and rule-based expression adjustment, which differ from conventional template-based or simple rule-based generation, thereby providing technical effects such as generation of natural conversation sentences optimized for each user, personalized conversation experience, and improved user satisfaction. Specific application fields include conversation support applications, personalized educational support, customer support automation, and health management support.

The presentation unit can analyze the user's past behavioral patterns based on the user's input and present small talk. For example, the presentation unit analyzes the content and context of text previously input by the user to identify behavioral patterns. The presentation unit can also analyze the user's past voice input to identify behavioral patterns. Furthermore, the presentation unit can analyze the user's past facial expressions to identify behavioral patterns. Thus, by presenting small talk based on the user's past behavioral patterns, the presentation unit can provide more appropriate small talk. Specifically, the presentation unit accepts as input small talk sentences received from the generation unit (natural language text, up to 256 tokens), behavioral pattern labels (e.g., “regular exercise,” “weekend outings,” “seasonal interest changes”), behavioral pattern fit scores (0.0-1.0) as structured data, and the user's past reaction history database (e.g., presentation method ID, presentation date/time, user reaction label, reaction intensity score, up to 1,000 entries). The presentation unit analyzes the presentation methods and styles (e.g., voice presentation, text display, notification format, color, font, animation effects) to which the user has shown favorable reactions in the past for each behavioral pattern using time-series analysis and clustering to select the optimal presentation method. For example, if the user has shown many favorable reactions to voice presentation during regular behavioral patterns, the presentation unit prioritizes voice presentation. If the user has shown many favorable reactions to casual text display during seasonal interest changes, the presentation unit selects display using casual colors or animation. The presentation unit generates structured data such as presentation method labels (e.g., “voice,” “text,” “notification”), behavioral pattern fit scores, and selection reasons as output and reflects them in the user interface. The presentation unit can also respond to changes in the user's device information and usage environment and dynamically switch the optimal presentation method. These processes are realized by computer-specific technical methods such as behavioral pattern estimation in high-dimensional feature space, reaction history analysis, and dynamic presentation method control, which differ from conventional simple text display or voice playback, thereby providing technical effects such as optimized presentation experience for each user, personalized conversation support, and improved user satisfaction. Specific application fields include conversation support applications, personalized educational support, customer support automation, and user-adaptive interface design.

The analysis unit can estimate the user's current environment and situation based on the user's input and enhance the accuracy of analysis. For example, the analysis unit analyzes the content and context of text input by the user to estimate the user's current environment and situation. The analysis unit can also analyze the user's voice input and estimate the current environment and situation from the tone of the user's voice and background sounds. Furthermore, the analysis unit can analyze the user's location information to estimate the user's current environment and situation. Thus, by enhancing the accuracy of analysis based on the user's current environment and situation, the analysis unit can obtain more appropriate analysis results. Specifically, the analysis unit accepts as input natural language text entered by the user (UTF-8, up to 512 tokens), voice data (16 kHz, 16 PCM waveform, up to 30 seconds), location information (GPS data: latitude, longitude, accuracy within 5m, with timestamp), and background sound features (e.g., labels from environmental sound classification models). The analysis unit uses pre-trained language models such as BERT or RoBERTa for text data to generate context embedding vectors (dimension 768) and outputs labels and probability distributions such as “indoor,” “outdoor,” “workplace,” “home,” and “in transit” using an environment/situation classification head. For voice data, the analysis unit uses acoustic features (MFCC, spectrogram) and environmental sound classification models (e.g., CNN-based) to estimate environment labels such as “quiet environment,” “noisy environment,” or “inside transportation.” For location information, the analysis unit cross-references geographic information databases (e.g., OpenStreetMap, regional topic dictionaries) to identify environments and situations related to the current location. For example, if the text contains “train” or “station,” the voice contains announcement sounds, and GPS indicates the vicinity of a station, the analysis unit estimates “in transit.” If the background sound is quiet and the location information indicates home, the analysis unit estimates “home.” The analysis unit integrates estimation results from these multiple modalities using ensemble methods to determine the final environment/situation label and score. According to the estimated environment/situation, the analysis unit dynamically adjusts parameters of subsequent feature extraction and topic extraction algorithms and personalizes input data for the generation unit. These processes are realized by computer-specific technical methods such as multimodal data integration in high-dimensional feature space, rule-based processing, and dynamic parameter control, which differ from conventional simple keyword extraction or subjective human judgment, thereby providing technical effects such as improved accuracy of environment/situation estimation for each user, personalized conversation generation, and optimization of user experience. Specific application fields include conversation support applications, mobility support services, personalized educational support, and customer support automation.

Below is a brief description of the processing flow of Example of the Embodiment. Specifically, the system realizes the generation and presentation of small talk from user input through cooperation among the analysis unit, generation unit, and presentation unit modules. First, the analysis unit accepts information input by the user (text, voice, image, social media posts, location information, sensor data, etc.). For text input, the analysis unit applies morphological analysis, named entity extraction, dependency structure analysis, topic modeling (e.g., LDA, BERTopic), clustering (e.g., K-means), and context embedding vector generation (e.g., BERT) to extract major topics and episode candidates. Voice input is converted to text by extracting acoustic features (MFCC, spectrogram) and using a speech recognition model (CTC-based), and similar natural language processing is applied. Image input is processed by extracting features using a CNN and generating text using an image captioning model, which is then integrated. Social media posts and location information are used to estimate the user's interests, environment, and behavioral patterns. The analysis unit integrates feature vectors, keyword lists, topic scores, emotion/condition/environment labels, and other data obtained from these diverse inputs and passes them as structured data to the generation unit. The generation unit applies a small talk generation algorithm (large-scale language model, prompt engineering, self-attention mechanism, category-specific generation algorithm, etc.) optimized for the user's preferences, style, mood, condition, behavioral patterns, and environment based on the received data to generate natural conversation sentences. The generation unit applies algorithms such as grammar checking, redundancy removal, control of detail, length, order, style, and mood fit to the generated results and selects the optimal small talk sentence. The presentation unit selects the optimal presentation method (text display, voice playback, notification, color/animation effects, etc.) based on the small talk sentence, style/mood/behavioral pattern/environment fit labels, and presentation method candidates received from the generation unit, as well as the user's device information, past reaction history, and current mood/condition/environment, and reflects them in the user interface. These series of processes are realized by computer-specific technical methods such as multimodal data integration in high-dimensional feature space, dynamic parameter control, and rule-based generation/presentation control, which differ from conventional human conversation support or simple template generation, thereby providing technical effects such as significant improvement in the accuracy, naturalness, diversity, and user satisfaction of personalized conversation generation and presentation. Specific application fields include conversation support applications, educational conversation practice tools, mental healthcare support, customer support automation, and personalized communication tools.

Step 1: The analysis unit analyzes information input by the user. The information input by the user includes text, voice, and images. The analysis unit analyzes text information using natural language processing technology, converts voice input to text using speech recognition technology, and analyzes the resulting text information. The analysis unit can also analyze image input using image recognition technology and perform analysis based on information extracted from images. Step 2: The generation unit uses a generation AI to generate small talk based on information extracted by the analysis unit. The generation AI uses a text generation AI (e.g., LLM) to generate small talk in a natural flow and can also generate small talk by combining related topics and episodes. Step 3: The presentation unit presents the small talk generated by the generation unit to the user. The presentation unit displays the generated small talk in text format and can also present small talk to the user using voice output. Furthermore, the generated small talk can be sent to the user's device so that the user can check the small talk at any desired timing. Specifically, in Step 1, the analysis unit accepts diverse inputs such as text data entered by the user (UTF-8, up to 512 tokens), voice data (16 kHz, 16 PCM waveform, up to 30 seconds), image data (224×224 pixel RGB images), social media post data (latest 100 post texts, UTF-8, up to 256 tokens), location information (GPS data), and sensor data (e.g., acceleration, heart rate). The analysis unit applies morphological analysis, named entity extraction, dependency structure analysis, topic modeling (LDA, BERTopic), clustering (K-means), and context embedding vector generation (e.g., BERT) to text input to extract major topics and episode candidates. Voice input is converted to text by extracting acoustic features (MFCC, spectrogram) and using a speech recognition model (CTC-based), and similar natural language processing is applied. Image input is processed by extracting features using a CNN and generating text using an image captioning model, which is then integrated. Social media posts and location information are used to estimate the user's interests, environment, and behavioral patterns. The analysis unit integrates feature vectors, keyword lists, topic scores, emotion/condition/environment labels, and other data obtained from these diverse inputs and passes them as structured data to the generation unit. In Step 2, the generation unit applies a small talk generation algorithm (large-scale language model, prompt engineering, self-attention mechanism, category-specific generation algorithm, etc.) optimized for the user's preferences, style, mood, condition, behavioral patterns, and environment based on the received data to generate natural conversation sentences. The generation unit applies algorithms such as grammar checking, redundancy removal, control of detail, length, order, style, and mood fit to the generated results and selects the optimal small talk sentence. In Step 3, the presentation unit selects the optimal presentation method (text display, voice playback, notification, color/animation effects, etc.) based on the small talk sentence, style/mood/behavioral pattern/environment fit labels, and presentation method candidates received from the generation unit, as well as the user's device information, past reaction history, and current mood/condition/environment, and reflects them in the user interface. These series of processes are realized by computer-specific technical methods such as multimodal data integration in high-dimensional feature space, dynamic parameter control, and rule-based generation/presentation control, which differ from conventional human conversation support or simple template generation, thereby providing technical effects such as significant improvement in the accuracy, naturalness, diversity, and user satisfaction of personalized conversation generation and presentation. Specific application fields include conversation support applications, educational conversation practice tools, mental healthcare support, customer support automation, and personalized communication tools.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned analysis unit, generation unit, and presentation unit is implemented, for example, in at least one of the smart device 14 and the data processing apparatus 12. For example, the analysis unit is implemented by a processor 46 of the smart device 14 and analyzes text information input by the user using natural language processing technology. The generation unit is implemented, for example, by a specific processing unit 290 of the data processing apparatus 12 and generates small talk using a generation AI. The presentation unit is implemented, for example, by a control unit 46A of the smart device 14 and displays the generated small talk in text format. The presentation unit may also present the small talk to the user using audio output. The correspondence between each unit and the device or control unit is not limited to the examples described above and various modifications are possible.

### Second Embodiment

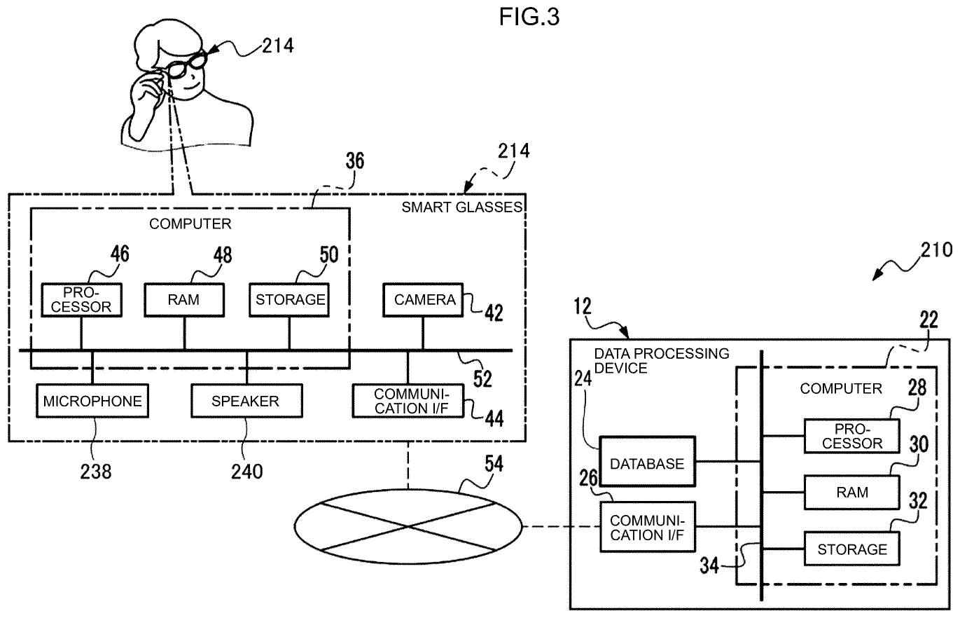

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

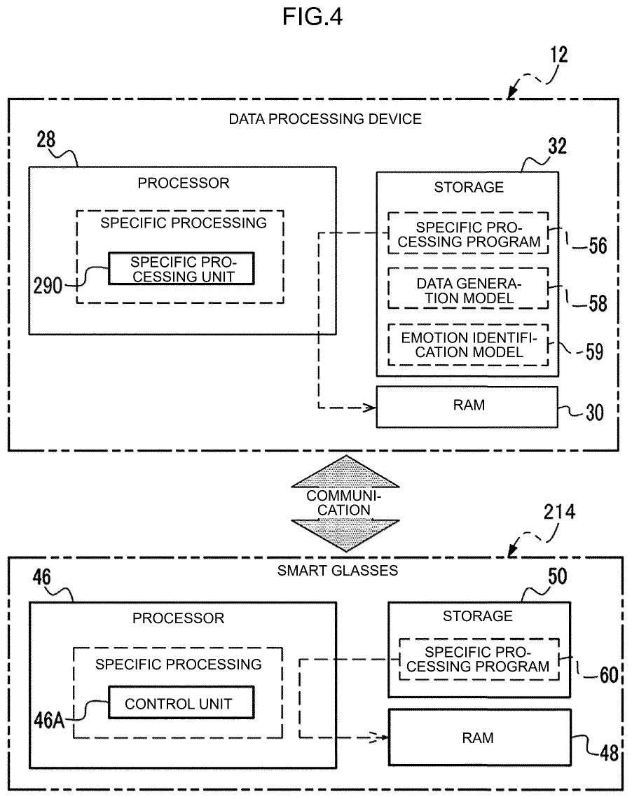

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned analysis unit, generation unit, and presentation unit is implemented, for example, in at least one of the smart glasses 214 and the data processing apparatus 12. For example, the analysis unit is implemented by a processor 46 of the smart glasses 214 and analyzes text information input by the user using natural language processing technology. The generation unit is implemented, for example, by a specific processing unit 290 of the data processing apparatus 12 and generates small talk using a generation AI. The presentation unit is implemented, for example, by a control unit 46A of the smart glasses 214 and displays the generated small talk in text format. The presentation unit may also present the small talk to the user using audio output. The correspondence between each unit and the device or control unit is not limited to the examples described above and various modifications are possible.

### Third Embodiment

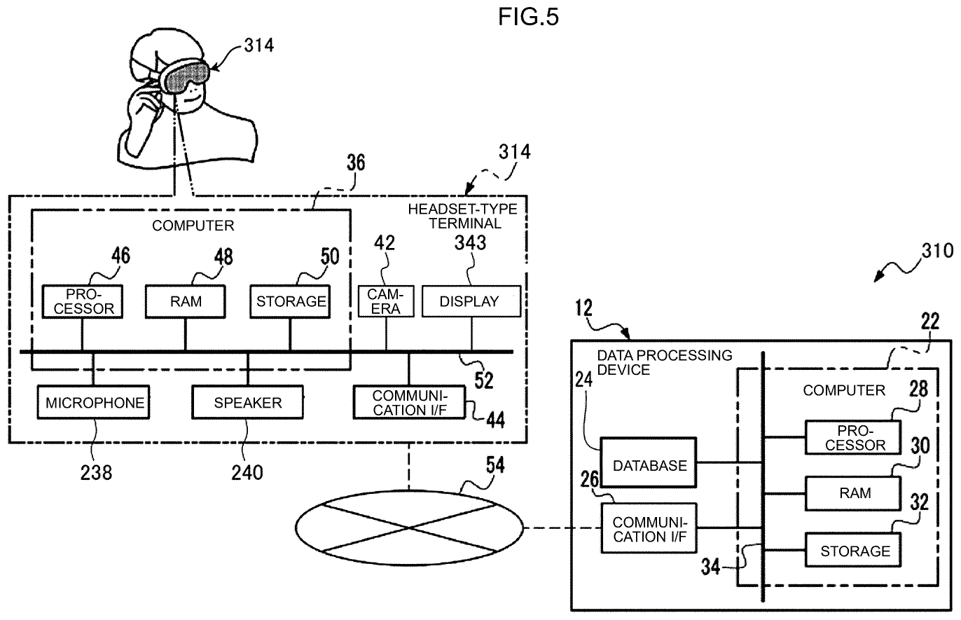

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

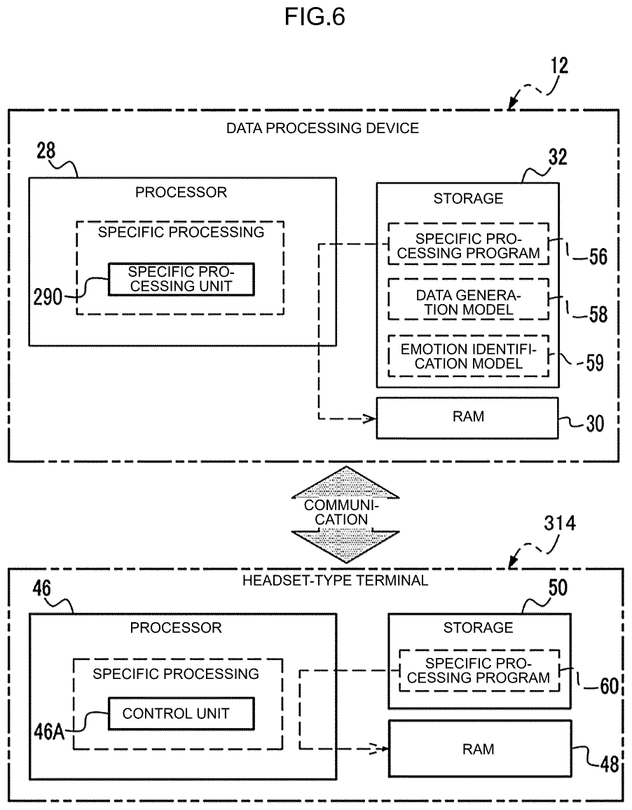

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned analysis unit, generation unit, and presentation unit is implemented, for example, in at least one of the headset-type terminal 314 and the data processing apparatus 12. For example, the analysis unit is implemented by a processor 46 of the headset-type terminal 314 and analyzes text information input by the user using natural language processing technology. The generation unit is implemented, for example, by a specific processing unit 290 of the data processing apparatus 12 and generates small talk using a generation AI. The presentation unit is implemented, for example, by a control unit 46A of the headset-type terminal 314 and displays the generated small talk in text format. The presentation unit may also present the small talk to the user using audio output. The correspondence between each unit and the device or control unit is not limited to the examples described above and various modifications are possible.

### Fourth Embodiment

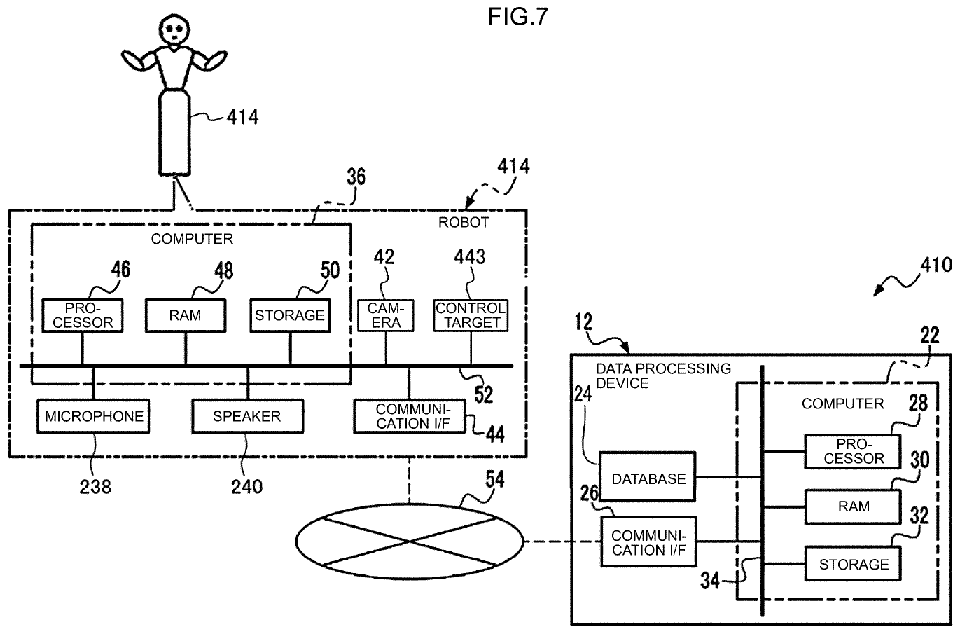

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

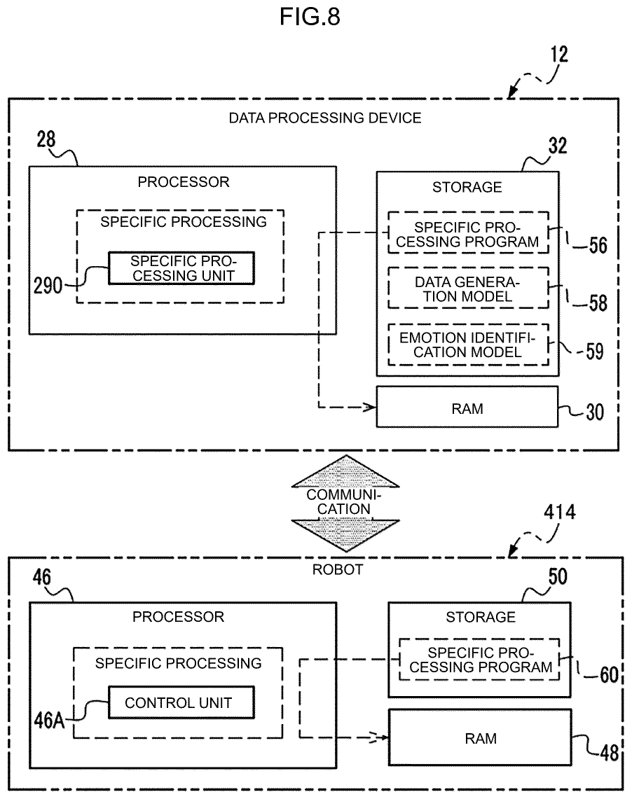

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned analysis unit, generation unit, and presentation unit is implemented, for example, in at least one of the robot 414 and the data processing apparatus 12. For example, the analysis unit is implemented by a processor 46 of the robot 414 and analyzes text information input by the user using natural language processing technology. The generation unit is implemented, for example, by a specific processing unit 290 of the data processing apparatus 12 and generates small talk using a generation AI. The presentation unit is implemented, for example, by a control unit 46A of the robot 414 and displays the generated small talk in text format. The presentation unit may also present the small talk to the user using audio output. The correspondence between each unit and the device or control unit is not limited to the examples described above and various modifications are possible.

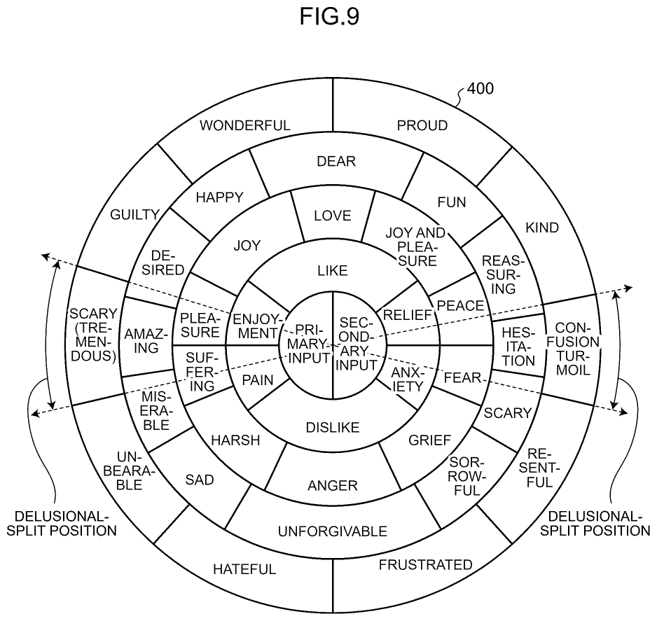

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

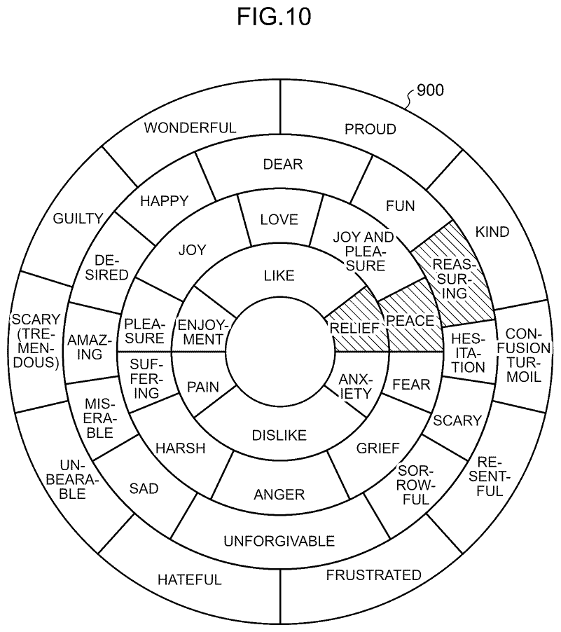

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: an analysis unit configured to analyze information input by a user; a generation unit configured to generate small talk based on information extracted by the analysis unit; and a presentation unit configured to present the small talk generated by the generation unit to the user.
(Supplementary Note 2)The system according to Supplementary Note 1, wherein the analysis unit is configured to analyze daily events or experiences input by the user and extract related topics or episodes.
(Supplementary Note 3)The system according to Supplementary Note 1, wherein the generation unit is configured to generate small talk in a natural flow based on the information extracted by the analysis unit.
(Supplementary Note 4)The system according to Supplementary Note 1, wherein the presentation unit is configured to present the generated small talk to the user.
(Supplementary Note 5)The system according to Supplementary Note 1, wherein the analysis unit is configured to estimate the user's emotion and enhance the accuracy of analysis based on the estimated emotion of the user.
(Supplementary Note 6)The system according to Supplementary Note 1, wherein the analysis unit is configured to analyze the user's past input history and select an appropriate analysis method.
(Supplementary Note 7)The system according to Supplementary Note 1, wherein the analysis unit is configured to perform filtering during analysis based on the user's current interests or trends.
(Supplementary Note 8)The system according to Supplementary Note 1, wherein the analysis unit is configured to estimate the user's emotion and determine the priority of topics to be analyzed based on the estimated emotion of the user.
(Supplementary Note 9)The system according to Supplementary Note 1, wherein the analysis unit is configured to prioritize and analyze highly relevant topics by considering the user's geographic location information during analysis.
(Supplementary Note 10)The system according to Supplementary Note 1, wherein the analysis unit is configured to analyze the user's social media activity during analysis and extract and analyze related topics.
(Supplementary Note 11)The system according to Supplementary Note 1, wherein the generation unit is configured to estimate the user's emotion and adjust the expression method of small talk based on the estimated emotion of the user.
(Supplementary Note 12)The system according to Supplementary Note 1, wherein the generation unit is configured to set the level of detail of small talk during generation based on the importance of topics.
(Supplementary Note 13)The system according to Supplementary Note 1, wherein the generation unit is configured to use different generation algorithms during generation according to the category of topics.
(Supplementary Note 14)The system according to Supplementary Note 1, wherein the generation unit is configured to estimate the user's emotion and adjust the length of small talk based on the estimated emotion of the user.
(Supplementary Note 15)The system according to Supplementary Note 1, wherein the generation unit is configured to set the priority of small talk during generation based on the submission timing of topics.
(Supplementary Note 16)The system according to Supplementary Note 1, wherein the generation unit is configured to set the order of small talk during generation based on the relevance of topics.
(Supplementary Note 17)The system according to Supplementary Note 1, wherein the presentation unit is configured to estimate the user's emotion and adjust the presentation method of small talk based on the estimated emotion of the user.
(Supplementary Note 18)The system according to Supplementary Note 1, wherein the presentation unit is configured to refer to the user's past reaction history during presentation and select an appropriate presentation method.
(Supplementary Note 19)The system according to Supplementary Note 1, wherein the presentation unit is configured to estimate the user's emotion and adjust the presentation order of small talk based on the estimated emotion of the user.
(Supplementary Note 20)The system according to Supplementary Note 1, wherein the presentation unit is configured to select an appropriate presentation method during presentation by considering the user's device information.

What is claimed is:

1. A system comprising:
circuitry configured to:
receive, from a client terminal via a communication interface and a packet-switched network, input data comprising at least one of text data, voice data, or image data;
estimate an emotion of a user by applying an emotion identification model to the input data;
analyze the input data using a natural language processing model to extract at least one of a keyword or a topic label;
generate, by inputting the extracted keyword or topic label and the estimated emotion into a data generation model obtained by deep learning on a neural network, inference data comprising natural language text; and
transmit the inference data to the client terminal via the communication interface and the packet-switched network, the inference data causing the client terminal to output the inference data to the user.

2. The system according to claim 1, wherein the circuitry is further configured to analyze daily events or experiences indicated by the input data and extract related topics or episodes as the keyword or topic label.

3. The system according to claim 1, wherein the circuitry is further configured to adjust an accuracy of analysis based on the estimated emotion, such that when the estimated emotion indicates relaxation, the circuitry performs detailed analysis and extracts a greater number of keywords, and when the estimated emotion indicates nervousness, the circuitry performs concise analysis and extracts fewer keywords.

4. The system according to claim 1, wherein the circuitry is further configured to analyze a past input history of the user stored in a database and select an analysis method based on the past input history.

5. The system according to claim 1, wherein the circuitry is further configured to perform filtering based on current interests or trends of the user by analyzing social media data received from the client terminal to identify current interests and extracting keywords matching the identified current interests.

6. The system according to claim 1, wherein the circuitry is further configured to determine a priority of keywords to be analyzed based on the estimated emotion, such that when the estimated emotion indicates relaxation, the circuitry prioritizes keywords based on interests of the user, and when the estimated emotion indicates nervousness, the circuitry prioritizes simple keywords.

7. The system according to claim 1, wherein the circuitry is further configured to receive geographic location information from the client terminal and prioritize extraction of keywords related to a geographic region corresponding to the geographic location information.

8. The system according to claim 1, wherein the circuitry is further configured to analyze social media activity data of the user received from the client terminal and extract keywords related to topics frequently mentioned by the user.

9. The system according to claim 1, wherein the circuitry is further configured to adjust an expression style of the inference data based on the estimated emotion, such that when the estimated emotion indicates relaxation, the inference data is generated in a casual expression style, and when the estimated emotion indicates nervousness, the inference data is generated in a polite expression style.

10. The system according to claim 1, wherein the circuitry is further configured to adjust a level of detail of the inference data based on an importance score associated with the keyword or topic label, such that for a keyword having a high importance score, the circuitry generates detailed inference data, and for a keyword having a low importance score, the circuitry generates concise inference data.

11. The system according to claim 1, wherein the circuitry is further configured to apply different generation algorithms according to a category of the keyword or topic label, such that for a keyword related to sports, the circuitry applies a sports-specific generation algorithm, and for a keyword related to travel, the circuitry applies a travel-specific generation algorithm.

12. The system according to claim 1, wherein the circuitry is further configured to adjust a length of the inference data based on the estimated emotion, such that when the estimated emotion indicates relaxation, the circuitry generates longer inference data, and when the estimated emotion indicates nervousness, the circuitry generates shorter inference data.

13. The system according to claim 1, wherein the circuitry is further configured to determine a priority of generating the inference data based on a submission timing associated with the input data, such that input data having a more recent submission timing is processed with a higher priority.

14. The system according to claim 1, wherein the circuitry is further configured to determine an order of presenting portions of the inference data based on a relevance score calculated from keyword co-occurrence frequency or contextual vector similarity.

15. The system according to claim 1, wherein the circuitry is further configured to select a presentation method of the inference data based on a past reaction history of the user stored in a database, the presentation method comprising at least one of text display or audio playback.

16. The system according to claim 1, wherein the circuitry is further configured to adjust a presentation order of the inference data based on the estimated emotion, such that when the estimated emotion indicates relaxation, the circuitry presents in a casual order, and when the estimated emotion indicates nervousness, the circuitry presents in a polite order.

17. The system according to claim 1, wherein the circuitry is further configured to select a presentation method based on device information of the client terminal received via the communication interface, the device information comprising at least one of a device type, an operating system version, or a screen resolution.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model;
a database; and
circuitry configured to:
receive, from the client terminal via the communication interface, input data comprising at least one of text data input via the touch panel, voice data captured by the microphone, or image data captured by the camera;
estimate an emotion of the user by applying the emotion identification model to the input data, the emotion identification model comprising at least one of a facial expression recognition model, a voice emotion recognition model, or a text emotion classification model;
analyze the input data using a natural language processing model based on a Transformer architecture to extract at least one of a keyword or a topic label, and generate a contextual embedding vector from the input data;
generate, by inputting the contextual embedding vector and the estimated emotion into the data generation model, inference data comprising natural language text;
adjust at least one of an expression style, a length, or a level of detail of the inference data based on the estimated emotion; and
transmit the inference data to the client terminal via the communication interface, the inference data causing the client terminal to output the inference data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface and a memory storing a data generation model obtained by deep learning on a neural network and an emotion identification model, the method comprising:
receiving, from a client terminal via the communication interface and a packet-switched network, input data comprising at least one of text data, voice data, or image data;
estimating an emotion of a user by applying the emotion identification model to the input data;
analyzing the input data using a natural language processing model to extract at least one of a keyword or a topic label;
generating, by inputting the extracted keyword or topic label and the estimated emotion into the data generation model, inference data comprising natural language text; and
transmitting the inference data to the client terminal via the communication interface and the packet-switched network, the inference data causing the client terminal to output the inference data to the user.
